(19) United States
(12) Patent Application Publication
(10) Pub. No.: US 2025/0390447 A1
(43) Pub. Date: Dec. 25, 2025

(54) Sideband Architecture For Power And Performance Subchannel And Channel-aware memory Controller Scheduling

(71) Applicant: QUALCOMM Incorporated, San Diego, CA (US)

(72) Inventors: Abhay RAJ, Lucknow (IN); Amulya Srinivasan MARGASAHAYAM, Bangalore (IN); Saurabh SETHI, MOHALI (IN); Vasantha Kumar Bandur PUTTAPPA, Bangalore (IN); Madhukar Reddy N, Hyderabad (IN); Raisana HOSSAIN, Kolkata (IN)

(21) Appl. No.: 18/748,173

(22) Filed: Jun. 20, 2024

(51) Int. Cl. G06F 13/16; G06F 9/50

(52) U.S. Cl. CPC G06F 13/1663; G06F 9/5033; G06F 13/1668

(57) ABSTRACT

Various embodiments include a computing system featuring a sideband architecture. The sideband architecture may include multiple memory controllers configured to connect to a shared upstream resource via multiple channels and to connect to corresponding memories via corresponding memory channels, and at least one sideband bus configured to connect the memory controllers and to transmit sideband connected memory controller signals between the memory controllers. The sideband bus may be configured to connect the memory controllers of one or more channels and memory channels. The sideband bus may be configured to connect the memory controllers of two or more subchannels and memory subchannels, including subchannels and memory subchannels within a channel and memory channel or across multiple channels and memory channels. Sideband connected memory controller signals may include memory controller information indicating whether a memory controller is performing or scheduled to perform a process causing congestion at the shared upstream resource.

### BACKGROUND

In the domain of Low Power Double Data Rate (LPDDR) memory technologies, particularly since the introduction of LPDDR4 and LPDDR5, channel-based memory schedulers managing data traffic have faced a significant challenge of congestion at shared upstream resources. This congestion arises when scheduling is blocked on two or more channels concurrently, resulting in system performance degradation. Specifically, this congestion can cause reduced bandwidth and increased power consumption within LPDDR systems. The introduction of subchannels in LPDDR6 has exacerbated the likelihood of congestion. The scheduling of these subchannels increases the complexity of managing the shared upstream resources, further heightening the probability of congestion.

### SUMMARY

Various aspects provide methods and apparatuses for implementing such methods that may include a first memory controller configured to connect to a shared upstream resource via a first channel and to connect to a first memory via a first memory channel, a second memory controller configured to connect to the shared upstream resource via a second channel and to connect to a second memory via a second memory channel, and a first sideband bus configured to connect the first memory controller with the second memory controller and transmit sideband connected memory controller signals between the first memory controller and the second memory controller.

Some aspects may further include a third memory controller configured to connect to the shared upstream resource via a third channel and to connect to a third memory via a third memory channel, in which the first sideband bus may be further configured to connect the first memory controller with the third memory controller, connect the second memory controller with the third memory controller, and transmit sideband connected memory controller signals between the first memory controller and the third memory controller and between the second memory controller and the third memory controller. In some aspects, the first channel, the second channel, and the third channel may be subchannels of a fourth channel, and the first memory channel, the second memory channel, and the third memory channel may be memory subchannels of a fourth memory channel.

Some aspects may further include a third memory controller configured to connect to the shared upstream resource via a third channel and to connect to a third memory via a third memory channel, and a second sideband bus configured to connect the first memory controller and the third memory controller and configured to transmit sideband connected memory controller signals between the first memory controller and the third memory controller. In some aspects, the first channel may be a first subchannel of a third channel and the second channel may be a second subchannel of the third channel, and the first memory channel may be a first memory subchannel of a third memory channel and the second memory channel may be a second memory subchannel of the third memory channel. In some aspects, the first channel may be a first subchannel of a third channel and the second channel may be a second subchannel of a fourth channel, and the first memory channel may be a first memory subchannel of a third memory channel and the second memory channel may be a second memory subchannel of a fourth memory channel.

In some aspects, the first sideband bus may be a parallel bus. In some aspects, the first sideband bus may be a serial bus.

In some aspects, the first memory controller may include a processor system configured to poll the second memory controller for memory controller information, identify whether the second memory controller is not performing a process for the second memory causing congestion at the shared upstream resource from the memory controller information, and provide a scheduler executed by the processor system with an indication to schedule a process for the first memory that uses the shared upstream resource in response to identifying that the second memory controller is not performing a process for the second memory causing congestion at the shared upstream resource.

In some aspects, the processor system may be further configured to identify whether the second memory controller is not scheduled to perform a process for the second memory causing congestion at the shared upstream resource from the memory controller information in response to identifying that the second memory controller is not performing a process for the second memory causing congestion at the shared upstream resource, and provide the scheduler executed by the processor system with the indication to schedule a process for the first memory that uses the shared upstream resource in response to identifying that the second memory controller is not performing a process for the second memory causing congestion at the shared upstream resource and identifying that the second memory controller is not scheduled to perform a process for the second memory causing congestion at the shared upstream resource.

In some aspects, in response to identifying that the second memory controller is not performing a process for the second memory causing congestion at the shared upstream resource the processor system may be further configured to identify whether the second memory controller is scheduled to perform a process for the second memory causing congestion at the shared upstream resource from the memory controller information, identify whether the first memory controller has priority to perform a process for the first memory using the shared upstream resource over the second memory controller, and provide the scheduler executed by the processor system with the indication to schedule a process for the first memory that uses the shared upstream resource in response to identifying that the second memory controller is scheduled to perform a process for the second memory causing congestion at the shared upstream resource, and identifying that the first memory controller has priority to perform a process for the first memory using the shared upstream resource over the second memory controller.

In some aspects, the process for the first memory may be at least one of an all-bank refresh, a per-bank refresh, transaction batching, DRAM memory calibration, or DRAM memory training.

In some aspects, the first memory controller may include a processor system configured to poll the second memory controller for memory controller information, identify whether the second memory controller is performing a process for the second memory causing congestion at the shared upstream resource from the memory controller information, and provide a scheduler executed by the processor system with an indication to postpone a process for the first memory using the shared upstream resource in response to identifying that the second memory controller is performing a process for the second memory causing congestion at the shared upstream resource.

In some aspects, the first memory controller may include a processor system configured to poll the second memory controller for memory controller information, identify whether the second memory controller is performing a process for the second memory causing congestion at the shared upstream resource from the memory controller information, identify whether a delay for implementing a process for the first memory using the shared upstream resource exceeds a delay threshold, and provide a scheduler executed by the processor system with an indication to schedule the process for the first memory using the shared upstream resource in response to identifying that the second memory controller is performing a process for the second memory causing congestion at the shared upstream resource and identifying that the delay for implementing the process for the first memory using the shared upstream resource exceeds the delay threshold.

Further aspects include a computing device including a memory and a processor configured to perform operations of any of the methods summarized above. Further aspects include a non-transitory processor system-readable storage medium having stored thereon processor system-executable software instructions configured to cause a processor to perform operations of any of the methods summarized above. Further aspects include a computing device having means for accomplishing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIGS. 2A-2C are component block diagrams illustrating example memory control systems with sideband architecture suitable for implementing various embodiments.

FIGS. 3A-3D are component block diagrams illustrating example memory control systems with sideband architecture suitable for implementing various embodiments.

FIG. 4 is a component block diagram illustrating an example processor system of a memory controller of a computing device configured for implementing subchannel and channel-aware memory controller scheduling using sideband architecture for implementing various embodiments.

FIG. 5 is a table diagram illustrating an example operation encoding and decoding table for implementing subchannel and channel-aware memory controller scheduling using sideband architecture for implementing various embodiments.

FIGS. 6A and 6B are timing and component block diagrams illustrating examples of implementing subchannel and channel-aware memory controller scheduling using sideband architecture in accordance with various embodiments.

FIGS. 7A and 7B are process flow diagrams illustrating example methods for subchannel and channel-aware memory controller scheduling using sideband architecture in accordance with various embodiments.

FIG. 8 is a component block diagram illustrating an example mobile computing device suitable for implementing various embodiments.

FIG. 9 is a component block diagram illustrating an example mobile computing device suitable for implementing various embodiments.

FIG. 10 is a component block diagram illustrating an example server suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include computing systems configured with a sideband architecture for memory systems. Some embodiments may include at least one sideband bus configured to connect at least two memory controllers, in which each memory controller may be connected to a shared upstream resource via a channel or subchannel. In some embodiments, the sideband bus may be configured to connect memory controllers of different channels, memory controllers of different subchannels of a same channel, and/or memory controllers of different subchannels of different channels. In some embodiments, the sideband bus may be a parallel communications bus or a serial communications bus. In some embodiments, two or more memory controllers may be connected via a sideband bus. In some embodiments, different groups of memory controllers, such as two or more memory controllers, may be connected via separate sideband buses.

Various embodiments include methods and computing devices implementing such methods for subchannel and channel-aware memory controller scheduling. Some embodiments may include transmitting memory controller information between memory controllers via a sideband bus. In some embodiments, the memory controller information may include information relating to active or scheduled processes causing congestion at a shared upstream resource by a sideband bus-connected memory controller. Some embodiments may include identifying, from the memory controller information received from the sideband bus connected memory controller, whether the sideband bus connected memory controller is performing a process for a corresponding memory causing congestion at the shared upstream resource. Some embodiments may include providing a scheduler with an indication to schedule or postpone scheduling a process for a corresponding memory that uses the shared upstream resources based on whether the sideband bus-connected memory controller is performing the process for the corresponding memory causing congestion at the shared upstream resource.

The term “computing device” is used herein to refer to stationary computing devices, including personal computers, desktop computers, all-in-one computers, workstations, supercomputers, mainframe computers, embedded computers (such as in vehicles and other larger systems), servers, multimedia computers, and game consoles. The terms “computing device” and “mobile computing device” are used interchangeably herein to refer to any of cellular telephones, smartphones, personal or mobile multi-media players, personal data assistants (PDAs), laptop computers, tablet computers, convertible laptops/tablets (2-in-1 computers), smartbooks, ultrabooks, netbooks, palm-top computers, wireless electronic mail receivers, multimedia Internet-enabled cellular telephones, mobile gaming consoles, wireless gaming controllers, and computing systems within vehicles that include a memory, and a programmable processor.

Various embodiments are described in terms of code, e.g., processor system-executable instructions, for ease and clarity of explanation, but may be similarly applicable to any data, e.g., code, program data, or other information stored in memory. The terms “code,” “data,” and “information” are used interchangeably herein and are not intended to limit the scope of the claims and descriptions to the types of code, data, or information used as examples in describing various embodiments.

In the domain of Low Power Double Data Rate (LPDDR) memory technologies, particularly since the introduction of LPDDR4 and LPDDR5 standards, channel-based memory schedulers managing data traffic have faced a significant challenge of congestion at shared upstream resources. This congestion arises when scheduling is blocked on two or more channels concurrently, resulting in congestion that can detrimentally affect system performance. Specifically, this congestion can cause reduced bandwidth and increased power consumption within LPDDR systems. The introduction of subchannels in LPDDR6 has exacerbated the likelihood of congestion. The scheduling of these subchannels increases the complexity of managing the shared upstream resources, further heightening the probability of congestion.

For example, for 4X refreshes, a majority of refresh commands are all-bank refreshes, which block DRAM accesses for approximately 280-390 ns. For multiple channels undergoing all-bank refresh in overlapping time intervals, instantaneous power draw is increased due to all-bank refreshes occurring in the same time interval (refresh is a leading factor in DRAM power). Increased power draw increases the thermal budget needed for cooling a computing device. Similar issues arise for multiple channels undergoing implementations of per-bank refresh, transaction batching, DRAM memory calibration, or DRAM memory training in overlapping time intervals.

Also, for multiple channels undergoing all-bank refreshes in overlapping time intervals, system performance is reduced due to congestion in the shared upstream resource. Congestion causes fewer DRAM-bound transactions to be serviced in the overlap period due to simultaneous bank unavailability due to all-bank refreshes. Congestion can also increase the wait time for transactions in the shared upstream resource, leading to backpressure upstream. Congestion can also cause quality of service (QOS) (priority, pressure) escalations for waiting transactions due to stalls, which can adversely affect scheduling in future intervals. QoS escalation can also cause a higher percentage of transactions to be affected by priority elevation due to stalls, causing inefficient scheduling.

Various embodiments overcome the preceding problems of scheduling concurrent use of the shared upstream resource by multiple channels or subchannels causing elevated power draw and congestion by providing a bus architecture and methods for sharing scheduling information between the channels and subchannels and methods for using the scheduling information to make scheduling decisions that avoid scheduling congestion at the shared upstream resource.

Various embodiments include a system and method for efficient scheduling in memory control systems with multiple subchannels or channels. Each subchannel's or channel's memory controller may be aware of the status of other memory controllers connected via a sideband bus through the use of sideband bus signals to share memory controller information, such as current bank status and refreshes.

Various embodiments may be applicable for current and future double data rate (DDR) memory specifications. Each memory controller may transmit/broadcast bank availability/unavailability status across subchannels or channels, and make scheduling decisions based on a bank unavailability period due to processes for the memory controller in other subchannels or channels. For example, the processes may be all-bank refreshes or per-bank refreshes. The memory controllers may ensure channels undergo refresh with less overlap across subchannels or channels.

Similarly, the processes may include any of transaction batching, DRAM memory calibration, or DRAM memory training. The memory controllers may ensure channels undergo any of these processes with less overlap across subchannels or channels. For example, batching algorithms in the memory controller may utilize information from the sideband bus signals to coordinate based on the system needs and the ongoing use case (high priority (HP)/non-HP). Various embodiments may be implemented for various memory levels, such as at the level of bank/bank group granularity across subchannels or channels.

The advantages of the embodiments may include improved auto concurrency use-cases, where all-bank refreshes are common occurrences (4X refresh), by increasing subchannel or channel availability and ensuring both subchannels or channels do not undergo all-bank refresh at the same time or reducing the overlap of bank unavailability period. Various embodiments may all reduce congestion at the shared upstream resource by keeping subchannels or channels aware of each other and may improve overall system QoS by preventing stalls due to congestion. All-bank refreshes on multiple subchannels or channels during the same time interval will increase the instantaneous power draw in the system. A thermal cooling budget may be reduced by reducing the overlap of refreshes across subchannels or channels, and DDR efficiency may be improved depending on how much overlap can be reduced by increasing channel availability.

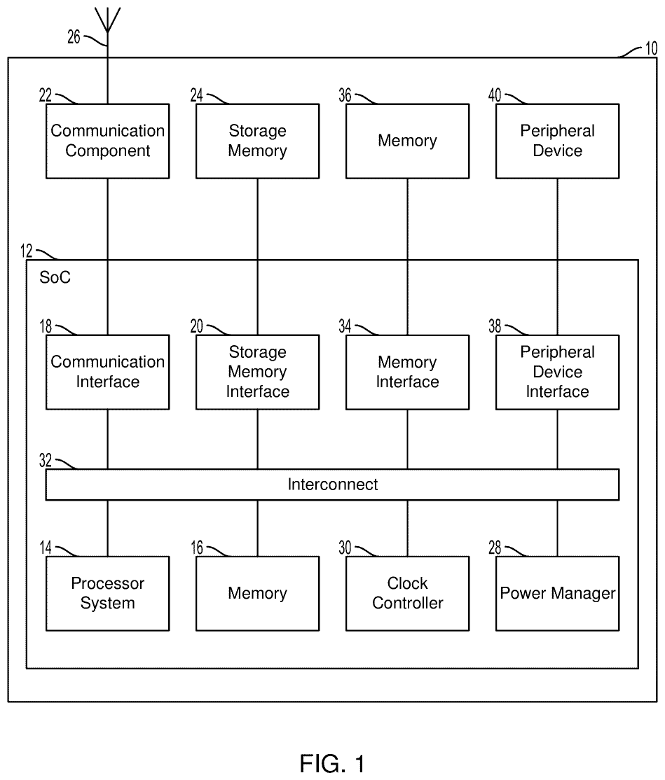

FIG. 1 illustrates a system including a computing device 10 suitable for use with various embodiments. With reference to FIG. 1, the computing device 10 may include a system-on-chip (SoC) 12 with a processor system 14, a memory 16, a communication interface 18, a storage memory interface 20, a memory interface 34, a power manager 28, a clock controller 30, a peripheral device interface 38, and an interconnect 32. The computing device 10 may further include a communication component 22, such as a wired or wireless modem, a storage memory 24, an antenna 26 for establishing a wireless communication link, a memory 36, and a peripheral device 40. The processor system 14 may refer to one or more processing devices, for example, one or more processors or one or more processor cores. The processor system 14 may include any of a variety of processing devices, including multiple processor cores.

The term “system-on-chip” (SoC) is used herein to refer to a set of interconnected electronic circuits typically, but not exclusively, including a processing device, a memory, and a communication interface. A processor system 14 may include a variety of different types of processors and processor cores, such as a general-purpose processor, a central processing unit (CPU), a digital signal processor (DSP), a graphics processing unit (GPU), an accelerated processing unit (APU), a secure processing unit (SPU), an artificial intelligence processing unit (AIPU), a subsystem processor of specific components of the computing device, such as an image processor for a camera subsystem or a display processor for a display, an auxiliary processor, a single-core processor, a multicore processor, a controller, and a microcontroller. A processor system 14 may further embody other hardware and hardware combinations, such as a field programmable gate array (FPGA), an application-specific integrated circuit (ASIC), other programmable logic devices, discrete gate logic, transistor logic, performance monitoring hardware, watchdog hardware, and time references. Integrated circuits may be configured such that the components of the integrated circuit reside on a single piece of semiconductor material, such as silicon.

An SoC 12 may include one or more processor systems 14. The computing device 10 may include more than one SoC 12, thereby increasing the number of processor systems 14, processors, and processor cores. The computing device ten may also include processor systems 14 that are not associated with an SoC 12. The processor systems 14 may each be configured for specific purposes that may be the same as or different from other processor systems 14 of the computing device 10. One or more of the processor systems 14, processors, or processor cores, of the same or different configurations may be grouped together. A group of processor systems 14, processors, or processor cores may be referred to as a multi-processor system cluster.

The memory 16, 36 for the SoC 12 may be a volatile or nonvolatile memory configured for storing data and processor system executable code for access by the processor system 14. The computing device 10 and/or SoC 12 may include one or more memories 16, 36 configured for various purposes. One or more memories 16, 36 may include volatile memories such as random access memory (RAM) or main memory or cache memory. For example, the memories 16, 36 may include any of static RAM (SRAM), dynamic RAM (DRAM), etc.

The memory 16, 36 may be configured to temporarily hold a limited amount of data received from a data sensor or subsystem, data and/or processor system-executable code instructions that are requested from a nonvolatile memory 16, 24, loaded to the memory 16, 36 from the nonvolatile memory 16, 24 in anticipation of future access based on a variety of factors, and/or intermediary processing data and/or processor system-executable code instructions produced by the processor system 14 and temporarily stored for future quick access without being stored in nonvolatile memory 16, 24.

The memory 16, 36 may include multiple physical memory components, such as memory chips, that may be logically combined and/or separated to form the memory 16, 36. The memory interface 34 and the memory 36 may work in unison to allow the computing device 10 to load and retrieve data and processor system-executable code on the memory 36.

The storage memory interface 20 and the storage memory 24 may work in unison to allow the computing device 10 to store data and processor system-executable code on a nonvolatile storage medium. The storage memory 24 may be configured much like an embodiment of the memory 16 in which the storage memory 24 may store the data or processor system-executable code for access by one or more of the processor systems 14. The storage memory 24, being nonvolatile, may retain the information after the power of the computing device 10 has been shut off. When the power is turned back on and the computing device 10 reboots, the information stored on the storage memory 24 may be available to the computing device 10. The storage memory 24 may include multiple physical memory components, such as storage memory drives, chips, discs, etc., that may be logically combined and/or separated to form the storage memory 24. The storage memory interface 20 may control access to the storage memory 24 and allow the processor system 14 to read data from and write data to the storage memory 24.

The power manager 28 may be configured to control power states of one or more power rails (not shown) for power delivery to the components of the SoC 12. In some embodiments, the power manager 28 may be configured to control the amounts of power provided to the components of the SoC 12. In some embodiments, the power manager 28 may be configured to control connections between components of the SoC 12 and the power rails. In some embodiments, the power manager 28 may be configured to control the amounts of power on each of the power rails connected to components of the SoC 12. The power manager 28 may be configured as a power management integrated circuit (PMIC).

A clock controller 30 may be configured to control clock signals transmitted to the components of the SoC 12. In some embodiments, the clock controller 30 may gate a component of the SoC 12 by disconnecting the component of the SoC 12 from a clock signal, and may ungate the component of the SoC 12 by connecting the component of the SoC 12 to the clock signal.

A peripheral device interface 38 may enable components of the SoC 12, such as the processor system 14 and/or the memory 16, to communicate with a peripheral device 40. The peripheral device interface 38 may provide and manage physical and logical connections between the components of the SoC 12 and the peripheral device 40. The peripheral device interface 38 may also manage communication between the components of the SoC 12 and the peripheral device 40, such as by directing and/or allowing communications between transmitter and receiver pairs of the components of the SoC 12 and the peripheral device 40 for a communication. The communications may include the transmission of memory access commands, addresses, data, interrupt signals, state signals, etc. A peripheral device 40 may be any component of the computing device 10 separate from the SoC 12, such as a processor system, a memory, a subsystem, etc. In some embodiments, the peripheral device interface 38 may include a PCIe root complex and may enable PCIe protocol communication between the components of the SoC 12 and the peripheral device 40. In some embodiments, the peripheral device 40 may be a component of the SoC 12.

The interconnect 32 may be a communication fabric, such as a communication bus, configured to communicatively connect the components of the SoC 12. The interconnect 32 may transmit signals between the components of the SoC 12. In some embodiments, the interconnect 32 may be configured to control signals between the components of the SoC 12 by controlling the timing and/or transmission paths of the signals.

Some or all of the components, including components of the SoC 12, connected to the SoC 12, and the SoC 12, of the computing device 10 may be arranged differently, separated, and/or combined while still serving the functions of the various embodiments. The computing device 10 may not be limited to one of each of the components, and multiple instances of each component may be included in various configurations of the computing device.

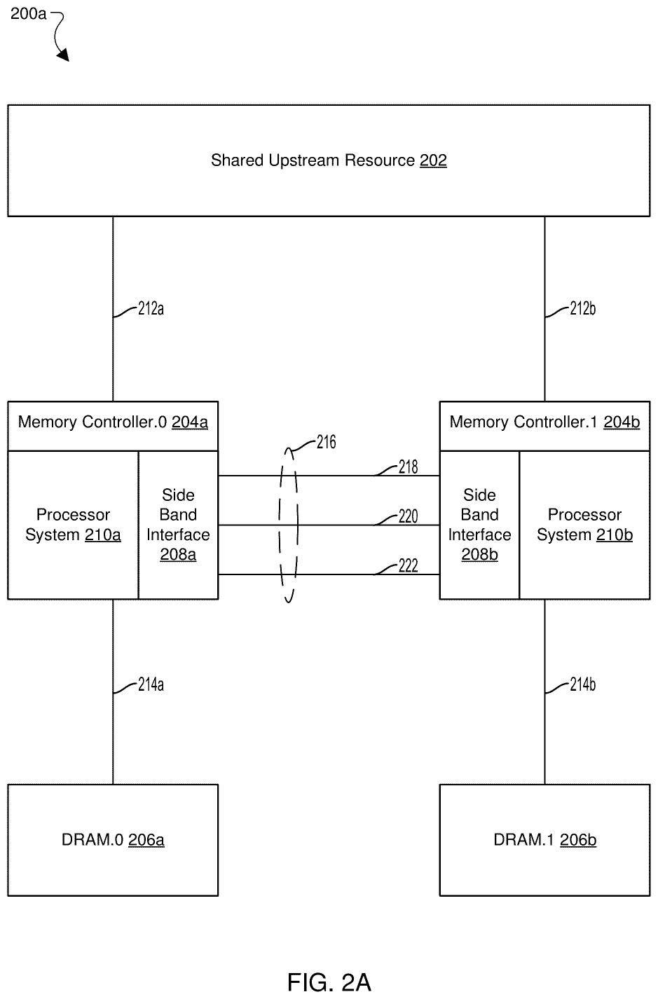

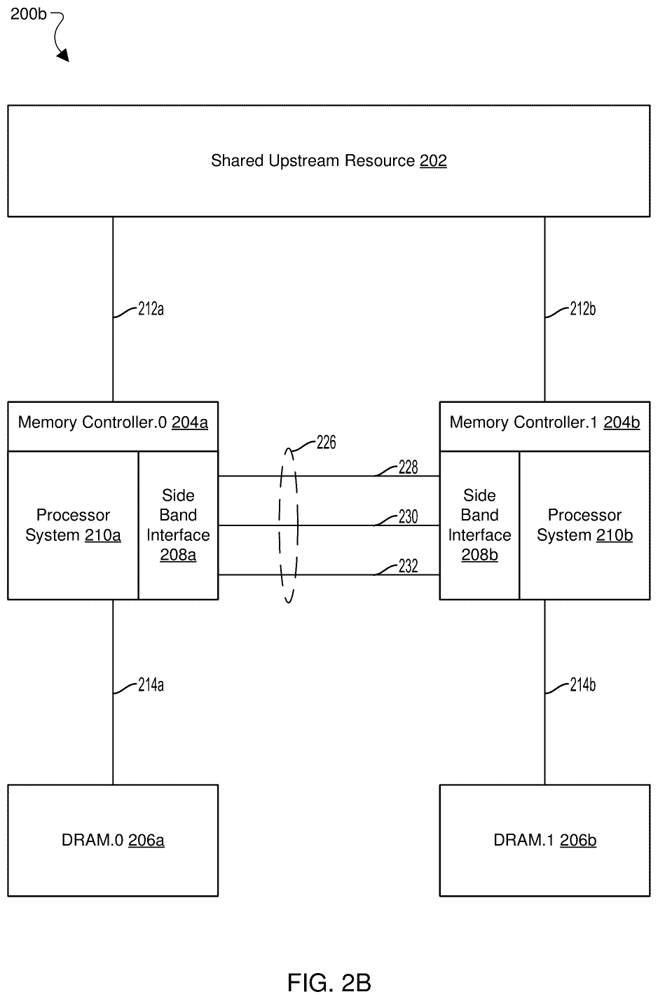

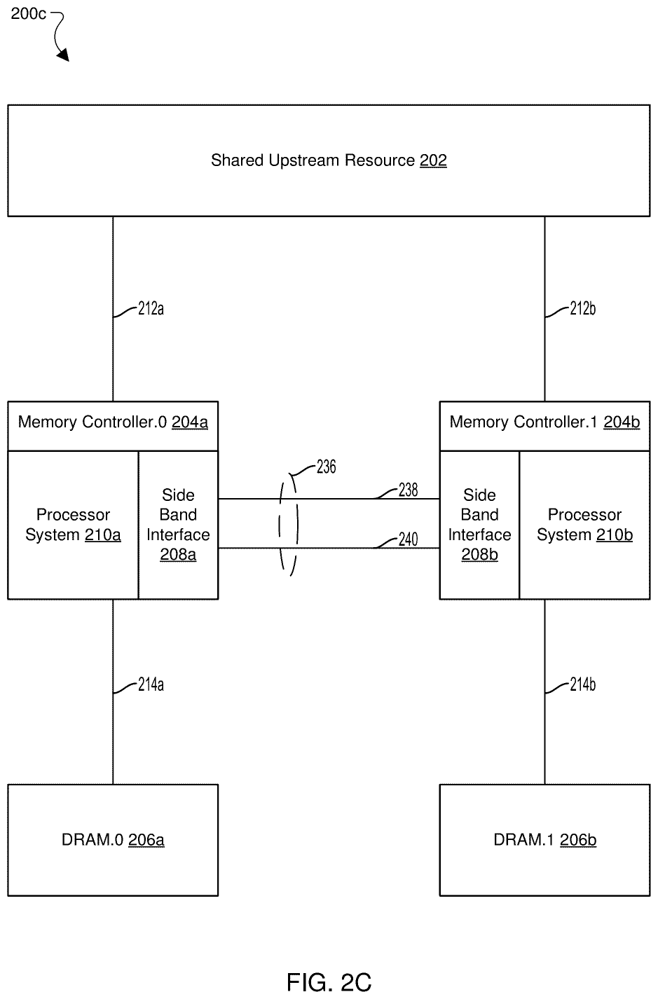

FIGS. 2A-2C illustrate examples of memory control systems 200a, 200b, 200c, with sideband architecture suitable for implementing various embodiments. With reference to FIGS. 1-2C, the memory control systems 200a, 200b, 200c may include any number and combination of at least two memory controllers 204a, 204b (e.g., memory interface 34 in FIG. 1), each communicatively connected to a shared upstream resource 202 (e.g., memory 16, 36, interconnect 32, storage memory 24, peripheral device 40 in FIG. 1) and to a memory 206a, 206b (e.g., memory 16, 36 in FIG. 1). The examples illustrated in FIGS. 2A-2C include two memory controllers 204a, 204b (“memory controller.0”, “memory controller.1”) and two memories 206a, 206b (“DRAM.0”, “DRAM.1”) for clarity and ease of explanation, and the claims and specification are not limited to the number of components of the examples. The descriptions of the examples are similarly applicable to any number of memory controllers and memories greater than 2, such as 4, 6, 8, 10, 16, 32, 64, etc.

Any of the components of the memory control systems 200a, 200b, 200c may be components that are integral to or separate from an SoC (e.g., SoC 12 in FIG. 1). In some embodiments, the memory controllers 204a, 204b and the memories 206a, 206b may be integral to the SoC. In some embodiments, the memory controllers 204a, 204b and the memories 206a, 206b may be separate from the SoC. In some embodiments, a combination of the memory controllers 204a, 204b and the memories 206a, 206b may be integral to the SoC and separate from the SoC, such as memory controllers 204a, 204b integral to the SoC and memories 206a, 206b separate from the SoC, memory controllers 204a, 204b integral to the SoC and at least one memory 206a, 206b integral to the SoC and at least one memory 206a, 206b separate from the SoC, etc.

A memory controller 204a, 204b may be connected to a memory 206a, 206b via a memory subchannel 214a, 214b, or a memory channel. The memory controller 204a, 204b may be connected to the shared upstream resource 202 via a subchannel 212a, 212b, or a channel. In some embodiments, the memory controller 204a, 204b may be connected to the memory 206a, 206b via the memory subchannel 214a, 214b and to the shared upstream resource 202 via the subchannel 212a, 212b. In some embodiments, the memory controller 204a, 204b may be connected to the memory 206a, 206b via the memory channel and to the shared upstream resource 202 via the channel. In the memory control systems 200a, 200b, 200c including subchannels, the memory subchannels 214a, 214b may be part of a memory channel and the subchannels 212a, 212b may be part of a channel, or the memory subchannels 214a, 214b may each be part of separate memory channels and the subchannels 212a, 212b may each be part of separate channels.

The examples illustrated in FIGS. 2A-2C are described in terms of memory subchannels 214a, 214b and subchannels 212a, 212b for clarity and ease of explanation, and the claims and specification are not limited to memory subchannels and subchannels. The descriptions of the examples are similarly applicable to memory channels and channels.

The memory controller 204a, 204b may include a processor system 210a, 210b (e.g., processor system 14 in FIG. 1) configured to implement hardware, software, or firmware functions of the memory controller 204a, 204b. In some embodiments, the processor system 210a, 210b may be configured to transmit and receive commands and data via the memory subchannel 214a, 214b and the subchannel 212a, 212b, to implement memory access functions for host devices accessing the memory 206a, 206b and memory maintenance functions for the memory 206a, 206b. In some embodiments, the processor system 210a, 210b may be configured to implement a scheduler configured to schedule processes for the memory 206a, 206b for execution, some of which may include use of the shared upstream resource 202. Concurrent attempts to use the shared upstream resource 202 by multiple memory controllers 204a, 204b may cause congestion, such as deadlock.

In various embodiments, the memory control systems 200a, 200b, 200c may include a sideband architecture connecting at least two memory controllers 204a, 204b and enabling the memory controllers 204a, 204b to share memory controller information. The sideband architecture may include at least one sideband interface 208a, 208b at each memory controller 204a, 204b and a sideband bus 216, 226, 236 connecting the at least two memory controllers 204a, 204b. The sideband interface 208a, 208b may provide a physical connection to the sideband bus 216, 226, 236 and may be configured to transmit and receive sideband connected memory controller signals, which may include the memory controller information. In some embodiments, the sideband interface 208a, 208b may be configured to provide the memory controller information to the processor system 210a, 210b. In some embodiments, the sideband interface 208a, 208b may be configured to decode encoded memory controller information and provide the decoded memory controller information to the processor system 210a, 210b.

The memory controller information may include information relating to execution or scheduled execution of processes for the memory 206a, 206b that use the shared upstream resource 202 by the sideband bus connected memory controllers 204a, 204b. In some embodiments, the memory controller information may include memory portion status for one or more portions of the memory 206a, 206b. The memory portion may be one or more rows, columns, partitions, banks, chips, ranks, etc. associated with the memory subchannel 214a, 214b connecting the memory 206a, 206b and the memory controller 204a, 204b. In some embodiments, the memory portion status may include an identifier of the memory portion and a value indicating a status of the memory portion. In various embodiments, the status may relate to: availability of the memory portion, such as memory portion refresh scheduling, such as for all-bank refresh; a command queue status, such as residency of commands in the command queue for read or write commands; batching information, such as a setting for priority batching of transactions or scheduling of batches of read or write commands; etc. In some embodiments, the memory controller information may include DDR/PHY calibrations and training information. In some embodiments, the memory controller information may include priority wise read or write batch scheduling information, such as batch size, batch type, etc. In some embodiments, the memory controller information may include command queue based statistics such as age, priority, time-out, etc. of command queue entries for read or write commands. In some embodiments, the memory controller information may include transaction identifiers based preferential scheduling across channels. The memory controller information may include any other information which may help in coordinating the memory controllers 204a, 204b for improved power and performance of the memory control systems 200a, 200b, 200c.

The processor system 210a, 210b may be further configured to evaluate the memory controller information received from the sideband interface 208a, 208b for making scheduling determinations relating to execution or scheduling execution of processes for the memory 206a, 206b that use the shared upstream resource 202 as discussed further herein.

The sideband bus 216, 226, 236 may be implemented in different configurations in the memory control systems 200a, 200b, 200c. The example illustrated in FIG. 2A of the memory control system 200a illustrates that the sideband bus 216 may be a parallel bus. The sideband interfaces 208a, 208b may be configured to transmit and receive memory controller information including encoded memory controller information transmitted in parallel.

The sideband bus 216 may include signal transmission components configured to transmit sideband connected memory controller signals 218, 220, 222 between the sideband interfaces 208a, 208b. In some embodiments, the sideband bus 216 may include signal transmission components configured to transmit a valid signal 218 from a memory controller 204a, 204b indicating that the memory controller information transmitted from the memory controller 204a, 204b is valid. In some embodiments, the sideband bus 216 may include signal transmission components configured to transmit encoded memory controller information including command signals 220, or operation code signals. In some embodiments, the sideband bus 216 may include signal transmission components configured to transmit encoded memory controller information including data signals 222. The encoded memory controller information is described in further detail herein.

The example illustrated in FIG. 2B of the memory control system 200b shows that the sideband bus 226 may be a parallel bus. The sideband interfaces 208a, 208b may be configured to transmit and receive memory controller information including uncoded memory controller information transmitted in parallel. The sideband bus 226 may include signal transmission components configured to transmit sideband connected memory controller signals 228, 230, 232 between the sideband interfaces 208a, 208b. In some embodiments, the sideband bus 226 may include signal transmission components configured to transmit a valid signal 228 from a memory controller 204a, 204b indicating that the memory controller information transmitted from the memory controller 204a, 204b is valid. In some embodiments, the sideband bus 226 may include signal transmission components configured to transmit a read signal 230 of a handshake procedure indicating that the memory controller 204a, 204b is ready to transmit or receive memory controller information. In some embodiments, the sideband bus 226 may include signal transmission components configured to transmit uncoded memory controller information signal 232, which may include any of the memory controller information for the memory controller 204a, 204b of the transmitting sideband interface 208a, 208b.

The example illustrated in FIG. 2C of the memory control system 200c shows that the sideband bus 236 may be a serial bus. The sideband interfaces 208a, 208b may be configured to transmit and receive memory controller information including uncoded memory controller information transmitted serially. The sideband bus 236 may include signal transmission components configured to transmit sideband connected memory controller signals 238, 240 between the sideband interfaces 208a, 208b. In some embodiments, the sideband bus 236 may include signal transmission components configured to transmit a clock signal 238 from a memory controller 204a, 204b indicating timing control for transmitted from the memory controller 204a, 204b. In some embodiments, the sideband bus 236 may include signal transmission components configured to transmit uncoded memory controller information signal 240, which may include any of the memory controller information for the memory controller 204a, 204b of the transmitting sideband interface 208a, 208b.

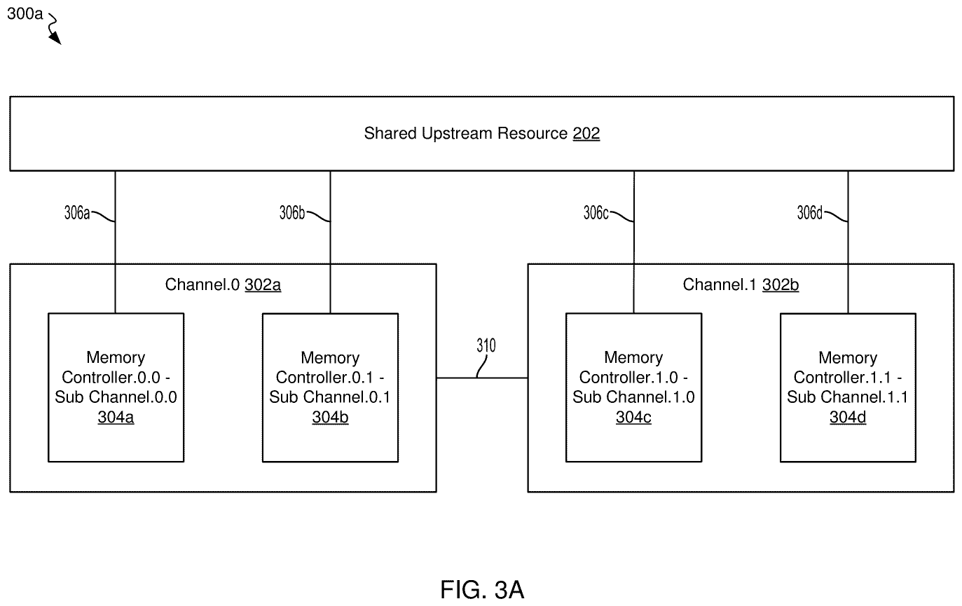

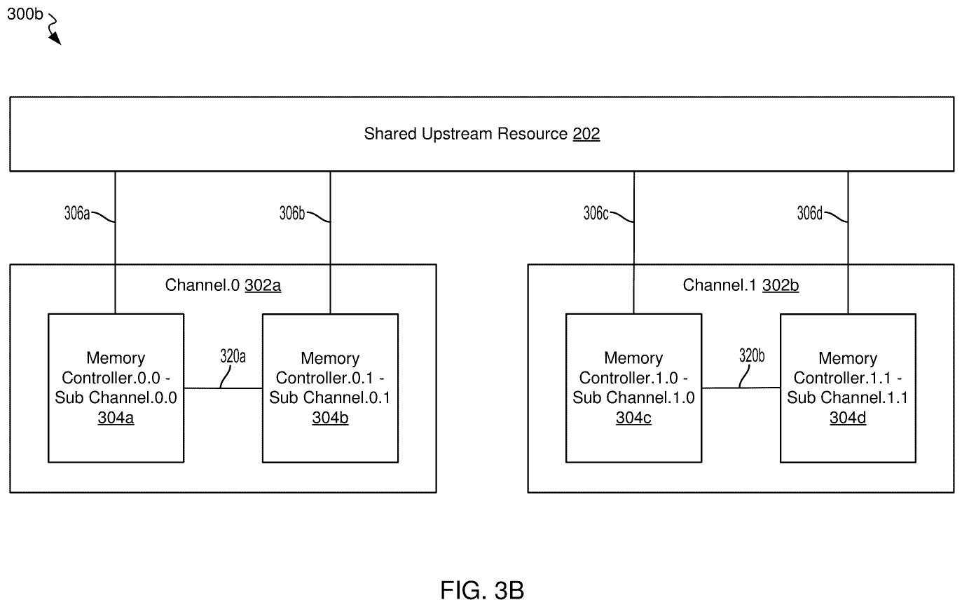

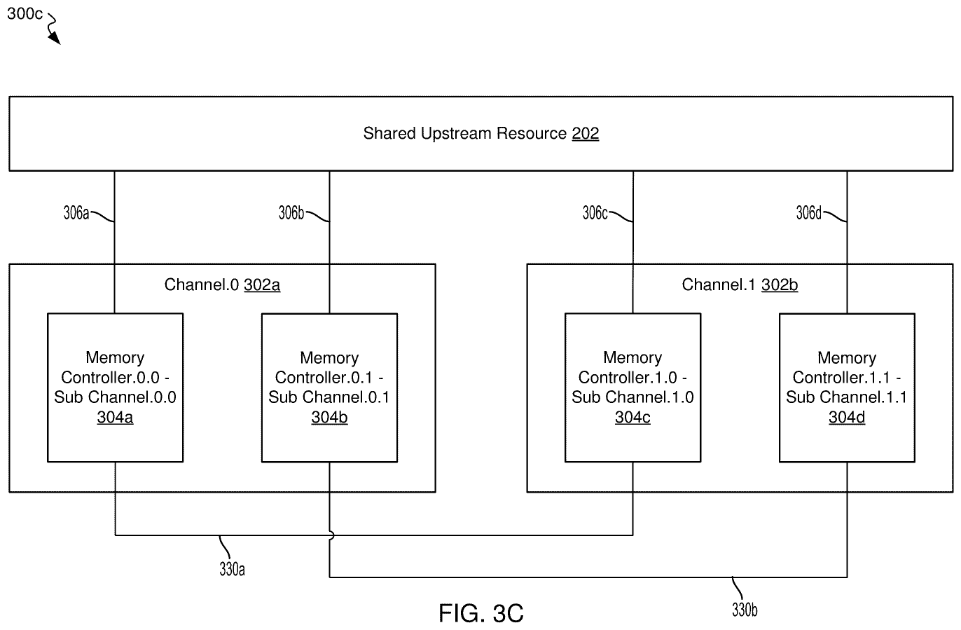

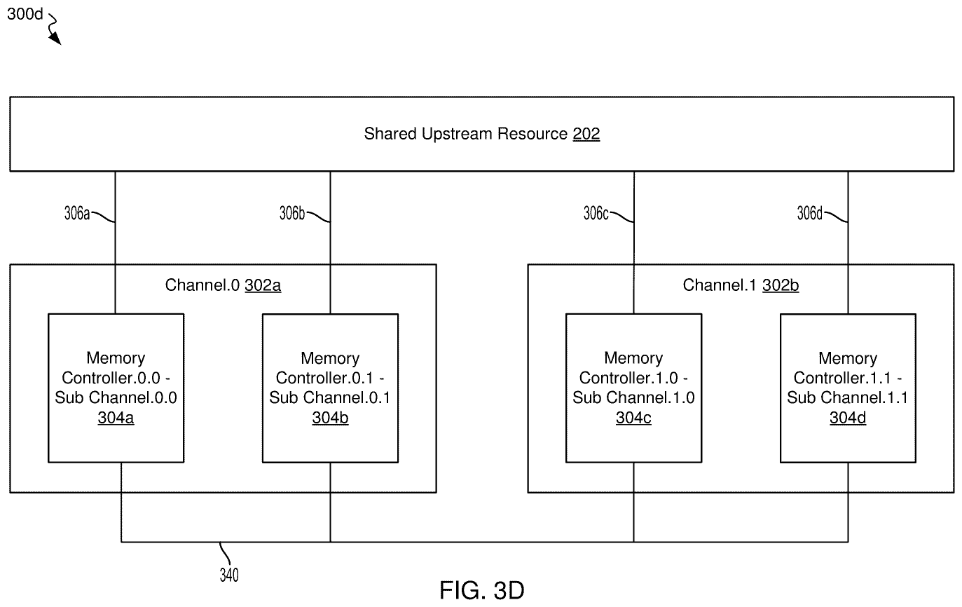

FIGS. 3A-3D illustrate examples of memory control systems 300a, 300b, 300c, 300d (e.g., memory control system 200a-200c in FIGS. 2A-2C) with sideband architecture suitable for implementing various embodiments. With reference to FIGS. 1-3D, the memory control systems 300a, 300b, 300c, 300d may include any number and combination of at least two memory controllers 304a, 304b, 304c, 304d (e.g., memory interface 34 in FIG. 1, memory controller 204a, 204b in FIGS. 2A-2C), each communicatively connected to a shared upstream resource 202 (e.g., memory 16, 36, interconnect 32, storage memory 24, peripheral device 40 in FIG. 1) and to a memory (e.g., memory 16, 36 in FIG. 1, memory 206a, 206b in FIGS. 2A-2C; not shown). Each memory controller 304a, 304b, 304c, 304d may be connected to the shared upstream resource 202 via a subchannel 306a, 306b, 306c, 306d (e.g., subchannel 212a, 212b in FIGS. 2A-2C) of a channel 302a, 302b.

The examples illustrated in FIGS. 3A-3D are described with connections of the memory controllers 304a, 304b, 304c, 304d to the shared upstream resource 202 via the subchannels 212a, 212b for clarity and ease of explanation, and the claims and specification are not limited to connections via subchannels. One of skill in the art would understand that the descriptions of the examples are similarly applicable to connections of memory controllers to the shared upstream resource via the channels, such as in a configuration of one memory controller in a channel. The examples illustrated in FIGS. 3A-3D include four memory controllers 304a, 304b, 304c, 304d (“memory controller.0.0”, “memory controller.0.1”, “memory controller. 1.0”, “memory controller. 1.1”) connected to the shared upstream resource 202 via four subchannel 306a, 306b, 306c, 306d of two channels 302a, 302b (“channel.0”, “channel.1”) for clarity and ease of explanation. The claims and specification are not limited to the number of components of the examples. One of skill in the art would understand that the descriptions of the examples are similarly applicable to any number of memory controllers, channels, and subchannels greater than 2, such as 4, 6, 8, 10, 16, 32, 64, etc. One of skill in the art would also understand that the descriptions of the examples are similarly applicable to various network or connection structures, such as star, mesh, pair, etc.

The sideband architecture of the memory control systems 300a, 300b, 300c, 300d may also include sideband buses 310, 320a, 320b, 330a, 330b, 340 (e.g., sideband bus 216, 226, 236 in FIGS. 2A-2C). Each of the sideband bus 310, 320a, 320b, 330a, 330b, 340 may be configured to connect at least two memory controllers 304a, 304b, 304c, 304d and transmit memory controller information between the at least two memory controllers 304a, 304b, 304c, 304d. Each sideband bus 310, 320a, 320b, 330a, 330b, 340 may connect the at least two memory controllers 304a, 304b, 304c, 304d at a subchannel level or a channel level. In some embodiments, the memory controller information may be for the memory controllers 304a, 304b, 304c, 304d at the subchannel level or the channel level. In other words, the memory controller information may be representative of a memory controller 304a, 304b, 304c, 304d of a subchannel 306a, 306b, 306c, 306d or one or more of the memory controllers 304a, 304b, 304c, 304d, such as all of the memory controllers 304a, 304b, 304c, 304d, of a channel 302a, 302b. A sideband bus 310, 320a, 320b, 330a, 330b, 340 may be configured as a parallel bus or as a serial bus.

FIG. 3A illustrates an embodiment of the memory control system 300a having a sideband bus 310 connecting the memory controllers 304a, 304b, 304c, 304d at the channel level. In other words, the memory controller information transmitted by the sideband bus 310 may be between one or more of the memory controllers 304a, 304b of one channel 302a and one or more of the memory controllers 304c, 304d of another channel 302b. The memory controller information may include identification of the transmitting memory controller 304a, 304b, 304c, 304d and/or identification of the channel 302a, 302b to which the transmitting memory controller 304a, 304b, 304c, 304d belongs. In some embodiments, the memory controller information may include or omit the subchannel 306a, 306b, 306c, 306d to which the transmitting memory controller 304a, 304b, 304c, 304d belongs.

FIG. 3B illustrates an embodiment of the memory control system 300b having the sideband bus 320a connecting the memory controllers 304a, 304b within the channel 302a, and the sideband bus 320b connecting the memory controllers 304c, 304d within the channel 302b. In other words, the memory controller information transmitted by the sideband bus 320a may be between two or more of the memory controllers 304a, 304b of one channel 302a, and the memory controller information transmitted by the sideband bus 320b may be between two or more of the memory controllers 304c, 304d of the channel 302b. The memory controller information may include identification of the transmitting memory controller 304a, 304b, 304c, 304d and/or identification of the subchannel 306a, 306b, 306c, 306d to which the transmitting memory controller 304a, 304b, 304c, 304d belongs. In some embodiments, the memory controller information may include or omit the channel 302a, 302b to which the transmitting memory controller 304a, 304b, 304c, 304d belongs.

FIG. 3C illustrates an embodiment of the memory control system 300c having the sideband bus 330a connecting the memory controllers 304a, 304c and the sideband bus 330b connecting the memory controllers 304b, 304d across the channels 302a, 302b. In other words, the memory controller information transmitted by the sideband bus 330a may be between two or more of the memory controllers 304a, 304c of different channels 302a, 302b, and the memory controller information transmitted by the sideband bus 330b may be between two or more of the memory controllers 304b, 304d of different channels 302a, 302b. The memory controller information may include identification of the transmitting memory controller 304a, 304b, 304c, 304d, and/or the subchannel 306a, 306b, 306c, 306d and/or the channel 302a, 302b to which the transmitting memory controller 304a, 304b, 304c, 304d belongs.

FIG. 3D illustrates an embodiment of the memory control system 300d having the sideband bus 340 connecting the memory controllers 304a, 304b, 304c, 304d within and across the channels 302a, 302b. In other words, the memory controller information transmitted by the sideband bus 340 may be between any two or more of the memory controllers 304a, 304b, 304c, 304d of the channels 302a, 302b. The memory controller information may include identification of the transmitting memory controller 304a, 304b, 304c, 304d, and/or the subchannel 306a, 306b, 306c, 306d and/or the channel 302a, 302b to which the transmitting memory controller 304a, 304b, 304c, 304d belongs.

In some embodiments, the sideband bus 310, 320a, 320b, 330a, 330b, 340 may be a shared bus connecting to two or more of the memory controllers 304a, 304b, 304c, 304d. In some embodiments, the sideband bus 310, 320a, 320b, 330a, 330b may be a shared sideband bus connecting the memory controllers 304a, 304b, 304c, 304d, and the memory controllers 304a, 304b, 304c, 304d may be configured to evaluate memory controller information from a certain one or more of the transmitting memory controllers 304a, 304b, 304c, 304d. In some embodiments, the sideband bus 340 may be a shared sideband bus connecting the memory controllers 304a, 304b, 304c, 304d, and the memory controllers 304a, 304b, 304c, 304d may be configured to evaluate memory controller information from any of the one or more of the transmitting memory controllers 304a, 304b, 304c, 304d.

In some embodiments, the sideband bus 310, 320a, 320b, 330a, 330b, 340 may be multiple buses connecting to two or more of the memory controllers 304a, 304b, 304c, 304d. For example, the sideband bus 310, 320a, 320b, 330a, 330b may be a multiple buses each connecting two or more of the memory controllers 304a, 304b, 304c, 304d, and the memory controllers 304a, 304b, 304c, 304d may be configured to evaluate memory controller information from connected transmitting memory controllers 304a, 304b, 304c, 304d.

In some embodiments, the memory control systems 300a, 300b, 300c, 300d may include memory controllers 304a, 304b, 304c, 304d configured for LPDDR6 standards. In some embodiments, the memory control systems 300a, 300b, 300d may include memory controllers 304a, 304b, 304c, 304d configured for LPDDR4 or LPDDR5 standards.

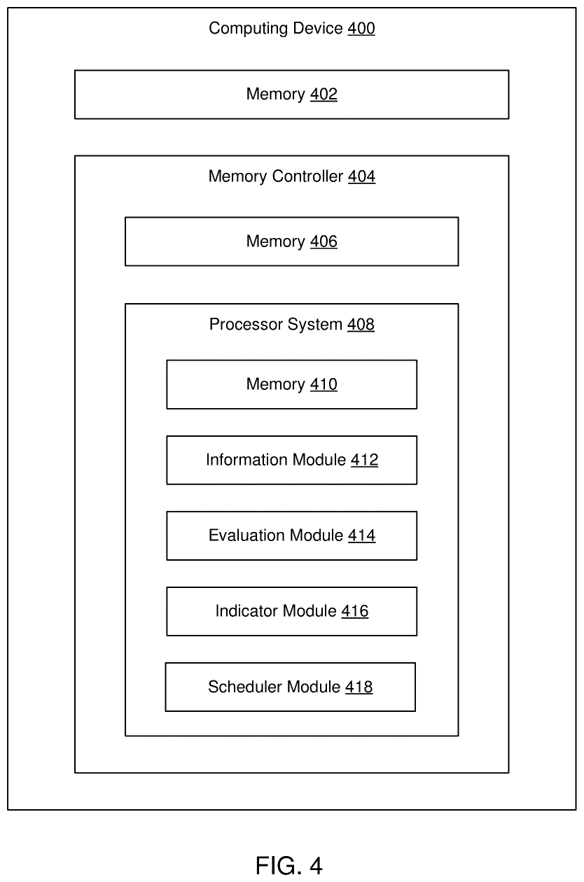

FIG. 4 illustrates an example processor system 408 (e.g., processor system 14, 210a, 210b in FIGS. 1-2C) of a memory controller 404 (e.g., memory interface 34 in FIG. 1, memory controller 204a, 204b, 304a-304d in FIGS. 2A-3D) configured for implementing subchannel and channel-aware memory controller scheduling using sideband architecture. With reference to FIGS. 1-4, the memory controller 404 may be part of a computing device 400 (e.g., computing device 10 in FIG. 1). The processor system 404 may be an integral component of the memory controller 404. The processor system 408 may include one or more modules 412-418 described further herein. Any one or more of the modules 412-418 may be implemented in hardware, software, firmware, or any combination thereof.

The processor system 408 may be configured with processor system-executable instructions of the one or more modules 412-418 for implementing functions of the one or more modules 412-418. The computing device may include a memory 402 (e.g., storage memory 24 in FIG. 1, memory 16, 36, 206a, 206b in FIGS. 1-2C) that may be a non-transitory processor system-readable medium storing the processor system-executable instructions of the one or more modules 412-418 for implementing functions of the one or more modules 412-418. The memory controller 404 and the processor system 408 may include a memory 406, 410 (e.g., memory 16, 36, 206a, 206b in FIGS. 1-2C) that may be a non-transitory processor system-readable medium storing the processor system-executable instructions of the one or more modules 412-418 for implementing functions of the one or more modules 412-418.

An information module 412 may be configured to request and/or receive memory controller information from one or more sideband connected memory controllers (e.g., memory interface 34 in FIG. 1, memory controller 204a, 204b, 304a-304d in FIGS. 2A-3D; not shown). In some embodiments, the information module 412 may be configured to generate a memory controller information request signal and transmit the signal to one or more of the one or more sideband connected memory controllers. For example, the information module 412 may transmit the memory controller information request signal directed to one or more of the one or more sideband connected memory controllers. In some embodiments, the information module 412 may transmit, or broadcast, the memory controller information request signal to all of the sideband connected memory controllers. The memory controller information request signal may be configured to prompt the receiving one or more sideband connected memory controllers respond by sending the memory controller information.

In some embodiments, the information module 412 may be configured to receive memory controller information from one or more of the sideband connected memory controllers without making a request. For example, the sideband connected memory controllers may periodically, episodically, or continuously transmit memory controller information. The sideband connected memory controllers may transmit memory controller information directed to the memory controller 404 or via broadcast. In some embodiments, the information module 412 may receive the memory controller information from one or more of the sideband connected memory controllers directed to the memory controller 404. In some embodiments, the information module 412 may receive the memory controller information broadcasted by one or more of the sideband connected memory controllers.

In some embodiments, the information module 412 may be configured to transmit memory controller information of the memory controller 404. The information module 412 may retrieve memory controller information from execution of the scheduler module 418 or from the memory 406, 410.

In some embodiments, the information module 412 may be configured to receive a memory controller information request signal from one or more of the sideband connected memory controllers and transmit the memory controller information in response to the signal. In some embodiments, the information module 412 may be configured to periodically, episodically, or continuously transmit the memory controller information, irrespective of a memory controller information request signal.

In some embodiments, the information module 412 may be configured to transmit the memory controller information directed to one or more of the sideband connected memory controllers. For example, the information module 412 may transmit the memory controller information directed to one or more of the sideband connected memory controllers from which a memory controller information request signal is received. In some embodiments, the information module 412 may be programmed to transmit the memory controller information directed to one or more of the sideband connected memory controllers. In some embodiments, the information module 412 may be configured to transmit the memory controller information directed to all of the sideband connected memory controllers via broadcast.

An evaluation module 414 may be configured to evaluate the memory controller information received from one or more of the sideband connected memory controllers. Evaluation of the memory controller information may be implemented to evaluate whether to recommend scheduling one or more processes for a memory (e.g., memory 16, 36 in FIG. 1, memory 206a, 206b in FIGS. 2A-2C) that uses a shared upstream resource (e.g., memory 16, 36, interconnect 32, storage memory 24, peripheral device 40 in FIG. 1, shared upstream resource 202 in FIGS. 2A-3D; not shown) to the scheduler module 418. The one or more processes for the memory that use the shared upstream resource may cause congestion at the shared upstream resource. Evaluation of the memory controller information may be implemented via one or more algorithms, heuristics, or other calculation or decision-making processes. The evaluation module 414 may be configured to identify whether a memory of one or more of the sideband connected memory controllers is executing or is planning to execute one or more processes for the memory that uses the shared upstream resource from the memory controller information.

The evaluation module 414 may also be configured to track a delay in implementing processes for the memory by the memory controller 404 that use the shared upstream resource. The delay may be caused, at least in part, by use or planned use of the shared upstream resource by a memory of one or more of the sideband connected memory controllers identified by the evaluation module 414. The evaluation module 414 may track the delay and compare the delay to a delay threshold to identify whether the delay exceeds the delay threshold. In some embodiments, the process may be an all-bank refresh of the memory 402 and the delay threshold may be a period of any units, such as time. In some embodiments, the delay threshold may be governed by JEDEC standards and may be or be equal to a multiple of a refresh window period.

The evaluation module 414 may also be configured to identify whether the memory controller 404 has priority to execute a process for the memory that uses the shared upstream resource over one or more of the sideband connected memory controllers that have planned execution of a process for a memory that uses the shared upstream resource. Priority may be implemented based on one or more parameters, such as an immutable order, a round robin based on use of the shared upstream resource, a least recently used determination based on use of the shared upstream resource, random assignment of priority, longest delay of implementation of processes, etc.

The evaluation module 414 may be configured to recommend scheduling one or more processes by the memory controller 404 for the memory that use the shared upstream resource based on some or all of the other functions of the evaluation module 414. In some embodiments, recommending scheduling the one or more processes by the memory controller 404 for the memory that use the shared upstream resource may be based on identification that one or more of the sideband connected memory controllers are not executing a process for a memory that uses the shared upstream resource. In some embodiments, recommending scheduling the one or more processes by the memory controller 404 for the memory that use the shared upstream resource may be based on identification that one or more of the sideband connected memory controllers are planning execution of a process for a memory that uses the shared upstream resource. In some embodiments, recommending scheduling the one or more processes by the memory controller 404 for the memory that use the shared upstream resource may be based on identification that the memory controller 404 has priority over one or more of the sideband connected memory controllers to execute a process for the memory that uses the shared upstream resource. In some embodiments, recommending scheduling the one or more processes by the memory controller 404 for the memory that use the shared upstream resource may be based on identification that the delay for implementing the one or more processes by memory controller 404 for the memory that use the shared upstream resource exceeds the delay threshold.

The evaluation module 414 may also be configured to recommend postponing scheduling the one or more processes by the memory controller 404 for the memory that use the shared upstream resource based on some or all of the other functions of the evaluation module 414. In some embodiments, recommending postponing scheduling the one or more processes by the memory controller 404 for the memory that use the shared upstream resource may be based on identification that one or more of the sideband connected memory controllers are executing a process for a memory that uses the shared upstream resource. In some embodiments, recommending postponing scheduling the one or more processes by the memory controller 404 for the memory that use the shared upstream resource may be based on identification that the delay for implementing the one or more process by memory controller 404 for the memory that use the shared upstream resource does not exceed the delay threshold.

An indicator module 416 may be configured to generate an indication to the scheduler module 418 configured to indicate whether to schedule or postpone scheduling the one or more processes by the memory controller 404 for the memory that use the shared upstream resource. The indication may be a signal or value based on the results of the functions implemented by the evaluation module 414. In some embodiments, the one or more processes, such as all-bank refreshes or per-bank refreshes, may benefit from staggered implementation between sideband connected memory controllers, and the indicator module 416 may be configured to generate an indication to postpone scheduling the one or more processes. In some embodiments, the one or more processes, such as transaction batching, DRAM memory calibration, or DRAM memory training, may benefit from synchronized implementation between sideband connected memory controllers, and the indicator module 416 may be configured to generate an indication to indicate to postpone scheduling the one or more processes. In some embodiments, synchronized implementation may be implementation of the processes by sideband connected memory controllers, which may include the memory controller 404, in a same period.

The scheduler module 418 may be configured to schedule the one or more processes by the memory controller 404 for the memory that use the shared upstream resource. The scheduler module 418 may take into consideration the indication from the indicator module 416 in scheduling the one or more processes by the memory controller 404 for the memory that use the shared upstream resource. The scheduler module 418 may also generate and provide to the information module 412 the memory controller information.

The foregoing describes the modules 412-418 in terms of a distributed memory control system (e.g., memory control system 200a-200c, 300a-300d in FIGS. 2A-3D) in which each memory controller implements the modules 412-416. In some embodiments, a centralized memory control system (e.g., memory control system 200a-200c, 300a-300d in FIGS. 2A-3D) may be implemented, in which at least some of the modules 412-418 are implemented by the memory controller 404 for one or more of the sideband connected memory controllers. For example, the evaluation module 414 may be configured to implement functions for one or more of the sideband connected memory controllers. The indicator module 416 may be configured to generate the indication to a scheduler module of one or more of the sideband connected memory controllers configured to indicate whether to schedule or postpone scheduling the one or more processes by one or more of the sideband connected memory controllers for one or more memories using the shared upstream resource. The indicator module 416 may be configured to transmit the indication to a scheduler module 418 of one or more of the sideband connected memory controllers.

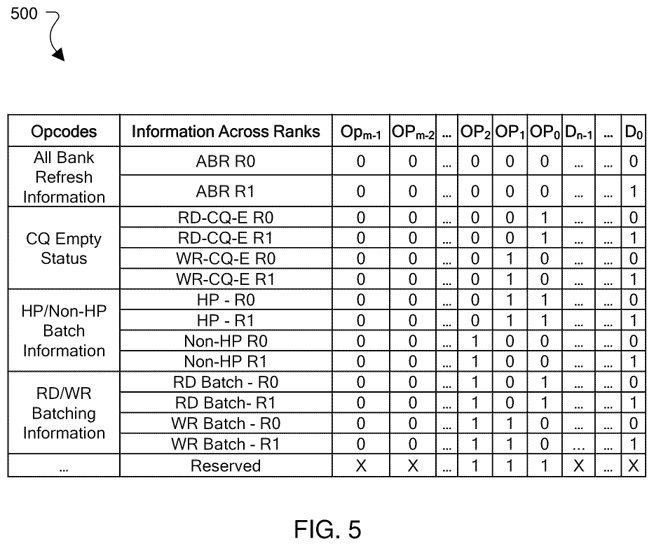

FIG. 5 illustrates an example operation encoding and decoding table 500 for implementing subchannel and channel-aware memory controller scheduling using sideband architecture for implementing various embodiments. With reference to FIGS. 1-5, the table 500 includes non-limiting examples of a manner by which to transmit memory controller information between memory controllers (e.g., memory interface 34 in FIG. 1, memory controller 204a, 204b, 304a-304d, 404 in FIGS. 2A-4) connected via a sideband bus (e.g., sideband bus 216, 226, 236, 310, 320a, 320b, 330a, 330b, 340 in FIGS. 2A-3D). In the example illustrated in FIG. 5, the memory controller information may be encoded bits of operation code (e.g., command signals 220 in FIG. 2A; “OP₀”-“OPₘ₋₁”) transmitted via a command bus of the sideband bus and/or encoded bits of operation code (e.g., data signals 222 in FIG. 2A; “D₀”-“Dₙ₋₁”) transmitted via a data bus of the sideband bus. The encoded bits of operation code may be transmitted and received by the sideband interfaces (e.g., band interface 208a, 208b in FIGS. 2A-2C) of the memory controllers.

In some embodiments, the sideband interfaces may be configured to encode memory controller information received from an information module (e.g., information module 412 in FIG. 4) and transmit the encoded memory controller information. The sideband interfaces may also be configured to decode the encoded memory controller information received from a sideband connected memory controller and provided the decoded memory controller to an information module.

The operation codes in the table 500 include all-bank refresh information, command queue (“CQ”) empty status, high priority/non-high priority (“HP/Non-HP”) batch information, and read/write (“RD/WR”) batching information. The all-bank refresh information may include an indication of whether a memory rank (“R0” or “R1”) is implementing an all-bank refresh (“ABR”). The command queue empty status may include an indication of whether s read (“RD”) or write (“WR”) command queue is empty (“E”) for a memory rank. The high priority/non-high priority batch information may include an indication of whether a batch transaction of read or write commands scheduled for a memory rank is designated as having high priority or not having high priority. In some embodiments, an indication of high priority may also be an indication that high priority batching is enabled. The read/write batching information may include an indication of whether a batch transaction of read or write commands is scheduled for a memory rank.

The operation codes in the example shown in FIG. 5 are described in terms of memory ranks; however, operation codes may be applied for any portion of a memory (e.g., memory 16, 36 in FIG. 1, memory 206a, 206b, 402 in FIGS. 2A-2C and 4), including rows, columns, partitions, banks, chips, etc. Further, the operations codes shown in the table 500 may be reduced, expanded, or substituted to include any information relating to use or scheduled use of a shared computing (e.g., memory 16, 36, interconnect 32, storage memory 24, peripheral device 40 in FIG. 1, shared upstream resource 202 in FIGS. 2A-3D; not shown) by the sideband bus connected memory controllers.

In some embodiments, the memory controller information may include a memory portion status for one or more portions of the memory. The memory portion may be one or more rows, columns, partitions, banks, chips, ranks, etc. of the memory. For example, the memory portion status may include an identifier of the memory portion and a value indicating a status of the memory portion. In various embodiments, the status may relate to: availability of the memory portion, such as memory portion refresh scheduling, such as for all-bank refresh; a command queue status, such as residency of commands in the command queue for read or write commands; batching information, such as a setting for priority batching of transactions or scheduling of batches of read or write commands; etc. In some embodiments, the memory controller information may include DDR/PHY calibrations and training information.

In some embodiments, the memory controller information may include priority-wise read or write batch scheduling information, such as batch size, batch type, etc. In some embodiments, the memory controller information may include command queue-based statistics such as age, priority, time-out, etc. of command queue entries for read or write commands. In some embodiments, the memory controller information may include transaction identifiers indicating preferential scheduling across channels. The memory controller information may include any other information that may help in coordinating the memory controllers for improved power and performance of the memory control system.

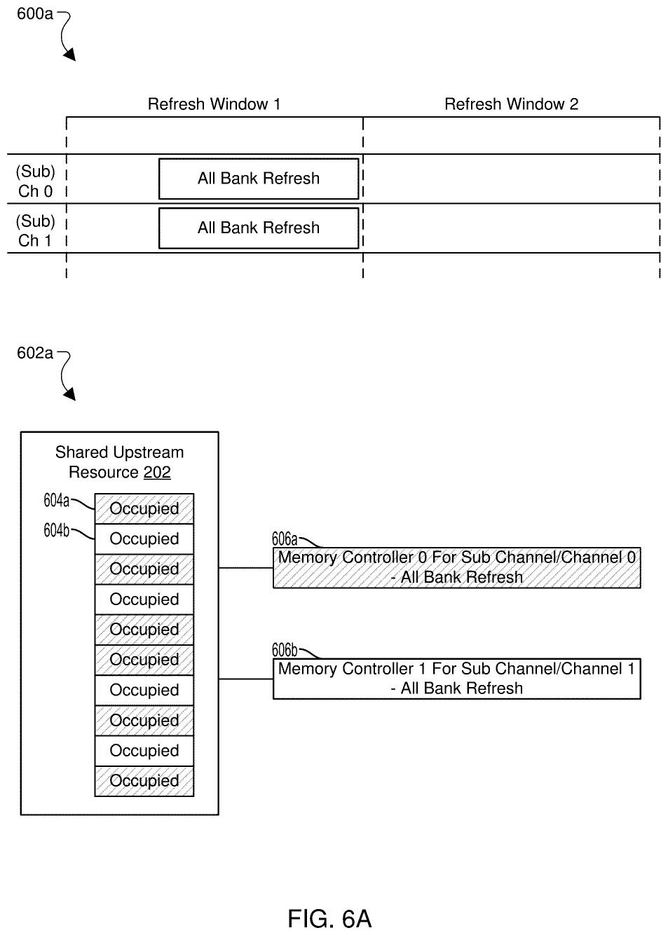

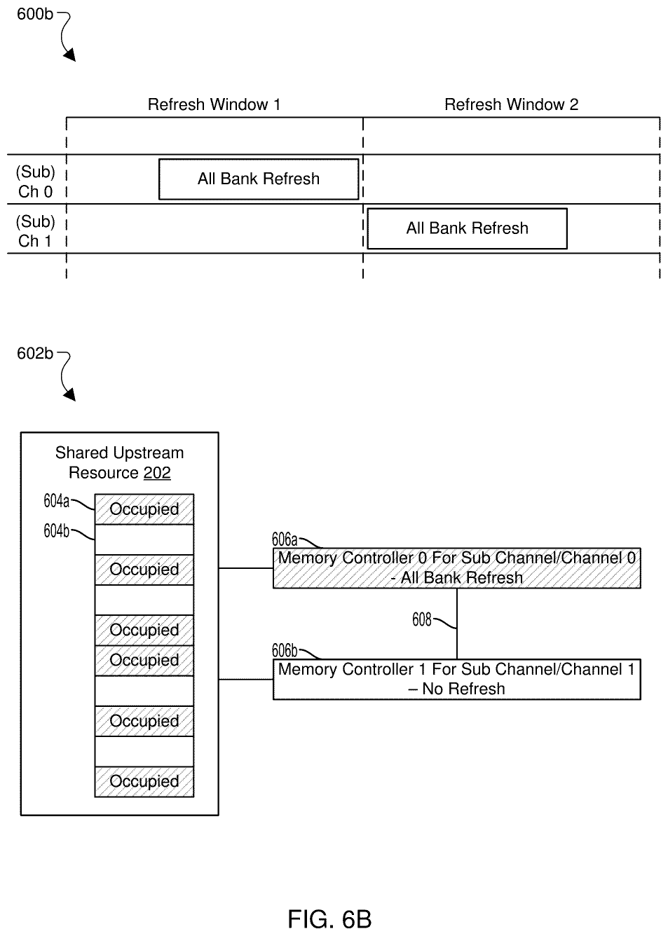

FIG. 6A illustrates an example of implementing typical memory controller scheduling and FIG. 6B illustrates an example of implementing subchannel and channel-aware memory controller scheduling using sideband architecture in accordance with various embodiments. With reference to FIGS. 1-6B, each example includes a timing diagram 600a, 600b for an example process implemented by memory controllers (e.g., memory interface 34 in FIG. 1, memory controller 204a, 204b, 304a-304d, 404 in FIGS. 2A-4) for a memory (e.g., memory 16, 36 in FIG. 1, memory 206a, 206b, 402 in FIGS. 2A-2C and 4; not shown) that uses a shared upstream resource 202 (e.g., memory 16, 36, interconnect 32, storage memory 24, peripheral device 40 in FIG. 1). The process in the examples is an all-bank refresh.

Each example also includes a memory control system 602a, 602b (e.g., memory control system 200a-200c, 300a-300d in FIGS. 2A-3D) in which the process in refresh window 1 of the timing diagram 600a, 600b, in the examples, the all-bank refresh for the memory is implemented. The memory control system 602a, 602b includes the shared upstream resource 202, including allocated portions 604a, 604b of the shared upstream resource 202, at least two memory controllers 606a, 606b, and memories associated with each memory controller 606a, 606b. The memory control system 602b in FIG. 6B also includes a sideband bus 608 (e.g., sideband bus 216, 226, 236, 310, 320a, 320b, 330a, 330b, 340 in FIGS. 2A-3D) connecting the memory controllers 606a, 606b.

In the example of typical memory controller scheduling illustrated in FIG. 6A, the all-bank refresh implemented by the memory controller 606a, associated with subchannel 0 or channel 0, is implemented in refresh window 1. The all-bank refresh implemented by the memory controller 606b, associated with subchannel 1 or channel 1, is also implemented in refresh window 1. The allocated portions 604a of the shared upstream resource 202 are being used or are occupied by the process implemented by the memory controller 606a in refresh window 1. The allocated portions 604b of the shared upstream resource 202 are being used or are occupied by the process implemented by the memory controller 606b in refresh window 1. As the memory controllers 606a, 606b are concurrently implementing the process in refresh window 1, congestion occurs as the memory controllers 606a, 606b attempts to concurrently access the shared upstream resource.

In the example of implementing subchannel and channel-aware memory controller scheduling using sideband architecture illustrated in FIG. 6B, the all-bank refresh implemented by the memory controller 606a, associated with subchannel 0 or channel 0, may be implemented in refresh window 1. The all-bank refresh implemented by the memory controller 606b, associated with subchannel 1 or channel 1, may be implemented in refresh window 2. The allocated portions 604a of the shared upstream resource 202 may be used or may be occupied by the process implemented by the memory controller 606a in refresh window 1. The allocated portions 604b of the shared upstream resource 202 may not be used or may not be occupied as the process may be implemented by the memory controller 606b in a different refresh window, such as refresh window two. As the memory controllers 606a, 606b may not concurrently implement the process in refresh window 1, congestion may be avoided as the memory controllers 606a, 606b may attempt to access the shared upstream resource in different refresh windows.

Based on memory controller information transmitted between the memory controllers 606a, 606b via the 608, the memory controllers 606a, 606b may implement subchannel and channel-aware memory controller scheduling. The result of implementing subchannel and channel-aware memory controller scheduling may be that the memory controllers 606a, 606b are enabled to schedule processes, in the examples, the all-bank refresh, in a manner that avoids contention for the shared upstream resource 202. In some embodiments, rather than scheduling processes for the memory controllers 606a, 606b to be implemented concurrently, the processes for the memory controllers 606a, 606b may be scheduled to be implemented in a staggered manner. Such as in the example illustrated in FIG. 6B, rather than scheduling the all-bank refresh for the memory controllers 606a, 606b in the same refresh window, as in the example illustrated in FIG. 6A, the all-bank refresh for the memory controllers 606a, 606b may be scheduled in different refresh windows.

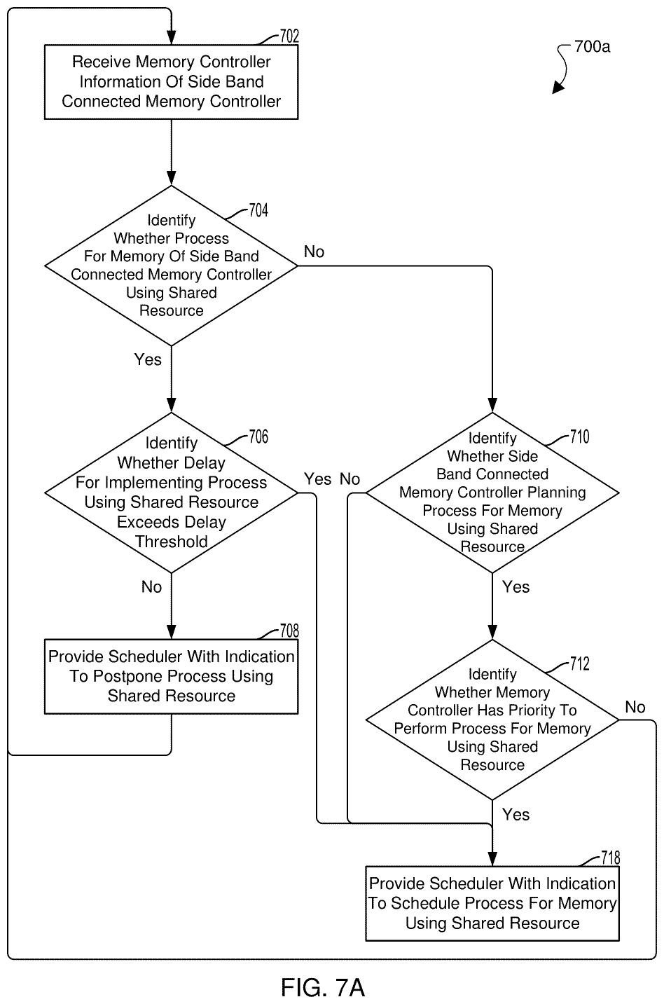

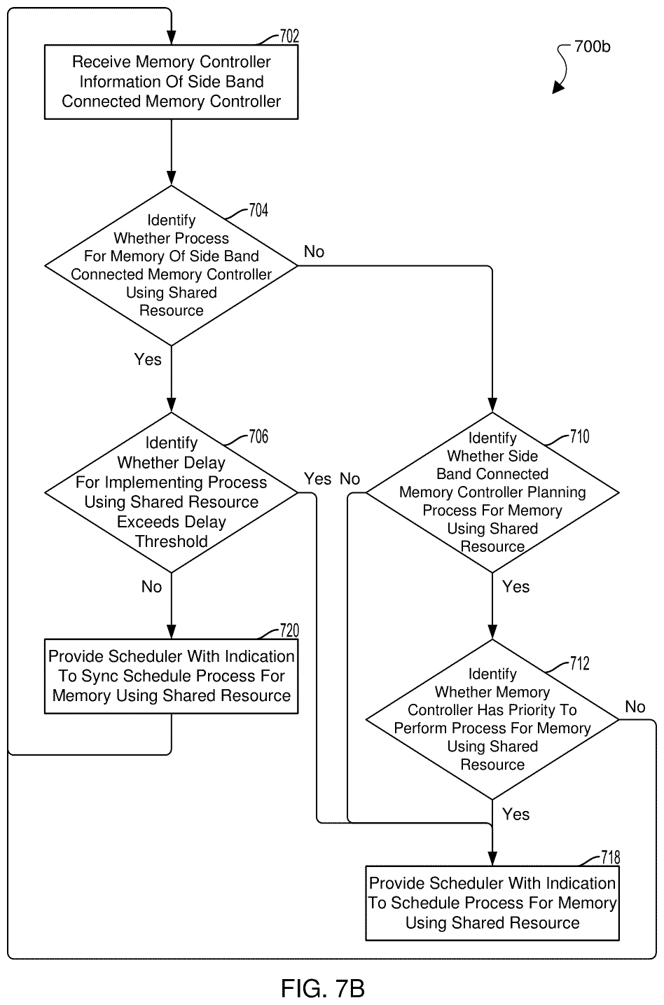

FIGS. 7A and 7B illustrates example methods for subchannel and channel-aware memory controller scheduling using sideband architecture according to an embodiment. With reference to FIGS. 1-7B, the methods 700a, 700b may be implemented in a computing device (e.g., computing device 10, 400 in FIGS. 1 and 4), in hardware (e.g., modules 412-418 in FIG. 4), in software (e.g., modules 412-418 in FIG. 4) executing in a processor system (e.g., processor system 14, 210a, 210b in FIGS. 1-2C, client 412 in FIG. 4), or in a combination of a software-configured processor and dedicated hardware, that includes other individual components, such as various memories/caches/registers/buffers (e.g., memory 16, 24, 36, 206a, 206b, 406, 410 in FIGS. 1-2C and 4) and memory controllers (e.g., memory interface 34 in FIG. 1, memory controller 204a, 204b, 304a-304d, 404, 606a, 606b in FIGS. 2A-4, 6A, and 6B). In order to encompass the alternative configurations enabled in various embodiments, the hardware implementing the methods 700a, 700b is referred to herein as a “memory control device.”

With reference to FIG. 7A, in the method 700a in block 702, the memory control device may receive memory control information from one or more sideband connected memory controllers (e.g., memory interface 34 in FIG. 1, memory controller 204a, 204b, 304a-304d, 404, 606a, 606b in FIGS. 2A-4 and 6B). In some embodiments, the memory control device receiving the memory control information from the one or more sideband connected memory controllers in block 702 may include a processor system (e.g., processor system 14, 210a, 210b in FIGS. 1-2C, client 412 in FIG. 4), a memory controller (e.g., memory interface 34 in FIG. 1, memory controller 204a, 204b, 304a-304d, 404, 606a, 606b in FIGS. 2A-4 and 6B), or an information module (e.g., information module 412 in FIG. 4).

In some embodiments, the memory control device may poll the one or more sideband connected memory controllers for the memory control information by transmitting a memory controller information request signal. In some embodiments, the memory controller information request signal may be directed to the one or more sideband connected memory controllers or broadcast to all of the sideband connected memory controllers.

The one or more sideband connected memory controllers may respond to the memory controller information request signal by transmitting the memory control information to the memory control device. In some embodiments, the one or more sideband connected memory controllers may transmit the memory control information to the memory control device periodically, episodically, or continuously irrespective of a memory controller information request signal. In some embodiments the memory controller information may be directed to the memory control device or broadcast to all of the sideband connected memory controllers.

The memory control device and the one or more memory controllers may be connected via one or more sideband buses (e.g., sideband bus 216, 226, 236, 310, 320a, 320b, 330a, 330b, 340, 608 in FIGS. 2A-3D and 6B). The memory controller information request signal and/or the memory controller information may be transmitted between the memory control device and the one or more sideband connected memory controllers via the one or more sideband buses.

In determination block 704, the memory control device may identify whether the one or more sideband connected memory controllers is performing one or more processes for one or more memories (e.g., memory 16, 36 in FIG. 1, memory 206a, 206b, 402 in FIGS. 2A-2C and 4) that use a shared upstream resource (e.g., memory 16, 36, interconnect 32, storage memory 24, peripheral device 40 in FIG. 1, shared upstream resource 202 in FIGS. 2A-3D and 6B) from the memory controller information. The one or more sideband connected memory controllers may be implementing one or more processes for the one or more memories that use and cause congestion at the shared upstream resource. The memory controller information may include an indication that the one or more sideband connected memory controllers is implementing one or more processes for the one or more memories that use the shared upstream resource. The memory control device may interpret the memory controller information to identify whether the one or more sideband connected memory controllers is implementing one or more processes for the one or more memories that use and cause congestion at the shared upstream resource. In some embodiments, the memory control device identifying whether the one or more sideband connected memory controllers is performing one or more processes for the one or more memories that use the shared upstream resource from the memory controller information in determination block 704 may include the processor system, the memory controller, or an evaluation module (e.g., evaluation module 414 in FIG. 4).

In response to identifying that the one or more sideband connected memory controllers is performing one or more processes for the one or more memories that use the shared upstream resource from the memory controller information (i.e., determination block 704 = “Yes”), the memory controller may identify whether a delay for implementing a process for a memory (e.g., memory 16, 36 in FIG. 1, memory 206a, 206b, 402 in FIGS. 2A-2C and 4) that uses the shared upstream resource exceeds a delay threshold in determination block 706. The memory controller may track a delay from when the process is requested. The delay may be tracked based on any units, such as time, and the delay may be compared to a delay threshold. The delay threshold may be a value of any process or for specific to the process for which the process may be delayed, and beyond which the process should be scheduled regardless of a use of the shared upstream resource by the one or more processes for the one or more memories performed by the one or more sideband connected memory controllers. In some embodiments, the memory control device identifying whether the delay for implementing the process for the memory that uses the shared upstream resource exceeds the delay threshold in determination block 706 may include the processor system, the memory controller, or the evaluation module.

In response to identifying that the delay for implementing the process for the memory that uses the shared upstream resource does not exceed the delay threshold (i.e., determination block 706=“No”), the memory control device may provide an indication to a scheduler (e.g., scheduler module 418 in FIG. 4), to postpone scheduling the process for the memory that uses the shared upstream resource in block 708. The memory control device may generate and transmit an indicator configured to indicate to the scheduler to postpone scheduling the process for the memory that uses the shared upstream resource. In some embodiments, the process for the memory that uses the shared upstream resource, such as all-bank refreshes or per-bank refreshes, may benefit from staggered implementation between sideband connected memory controllers. In some embodiments, the memory control device providing the indication to the scheduler to postpone scheduling the process for the memory that uses the shared upstream resource in block 708 may include the processor system, the memory controller, the evaluation module, or an indicator module (e.g., indicator module 416 in FIG. 4).

In response to identifying that the one or more sideband connected memory controllers is not performing one or more processes for the one or more memories that use the shared upstream resource from the memory controller information (i.e., determination block 704=“No”), the memory controller may identify whether the one or more sideband connected memory controllers are planning to perform one or more processes for the one or more memories that use the shared upstream resource from the memory controller information in determination block 710. The one or more sideband connected memory controllers may be scheduled to implement one or more processes for the one or more memories that use and cause congestion at the shared upstream resource. The memory controller information may include an indication that the one or more sideband connected memory controllers is scheduled to implement one or more processes for the one or more memories that use the shared upstream resource. The memory control device may interpret the memory controller information to identify whether the one or more sideband connected memory controllers is scheduled to implementing one or more processes for the one or more memories that use and cause congestion at the shared upstream resource. In some embodiments, the memory control device identifying whether the one or more sideband connected memory controllers is planning to perform one or more processes for the one or more memories that use the shared upstream resource from the memory controller information in determination block 710 may include the processor system, the memory controller, or the evaluation module.

In response to identifying that the one or more sideband connected memory controllers is planning to perform one or more processes for the one or more memories that use the shared upstream resource from the memory controller information (i.e., determination block 710=“Yes”), the memory controller may identify whether a sideband connected memory controller has priority to perform a process for the memory that uses the shared upstream resource in determination block 712. The priority of the sideband connected memory controller to perform a process for the memory that uses the shared upstream resource may be a priority over the one or more sideband connected memory controllers that plan perform one or more processes for the one or more memories that use the shared upstream resource. Priority may be implemented based on one or more parameters, such as an immutable order, a round robin based on use of the shared upstream resource, a least recently used determination based on use of the shared upstream resource, random assignment of priority, longest delay of implementation of processes, etc. In some embodiments, the memory control device identifying whether the sideband connected memory controller has priority to perform a process for the memory that uses the shared upstream resource in determination block 712 may include the processor system, the memory controller, or the evaluation module.

In response to identifying that the delay for implementing the process for the memory that uses the shared upstream resource exceeds the delay threshold (i.e., determination block 706=“Yes”); in response to identifying that the one or more sideband connected memory controllers is not planning to perform one or more processes for the one or more memories that use the shared upstream resource from the memory controller information (i.e., determination block 710=“No”); or in response to identifying that the sideband connected memory controller has priority to perform a process for the memory that uses the shared upstream resource (i.e., determination block 712=“Yes”), the memory control device may provide an indication to the scheduler to schedule the process for the memory that uses the shared upstream resource in block 718. The memory control device may generate and transmit an indicator configured to indicate to the scheduler to schedule the process for the memory that uses the shared upstream resource. In some embodiments, the memory that uses the shared upstream resource may be synchronized with or implemented in a same period as implementation of the one or more sideband connected memory controllers performing one or more processes for the one or more memories that use the shared upstream resource from the memory controller information. In some embodiments, the memory control device providing the indication to the scheduler to schedule the process for the memory that uses the shared upstream resource in block 718 may include the processor system, the memory controller, the evaluation module, or the indicator module.

After providing the indication to the scheduler to postpone scheduling the process for the memory that uses the shared upstream resource in block 708; or in response to identifying that the sideband connected memory controller does not have priority to perform a process for the memory that uses the shared upstream resource (i.e., determination block 712=“No”), the memory control device may receive memory control information from the one or more sideband connected memory controllers in block 702. In some embodiments, the memory control device receiving the memory control information from the one or more sideband connected memory controllers in block 702 may include the processor system, the memory controller, or the information module.

Referring to FIG. 7B, in the method 700b the memory control device may perform the operations in blocks 702-706 and 710-718 as described for the like numbered blocks in the method 700a as described with reference to FIG. 7A. Similar to the method 700a, the memory control device implementing the method 700b may include may include a processor system (e.g., processor system 14, 210a, 210b in FIGS. 1-2C, client 412 in FIG. 4), a memory controller (e.g., memory interface 34 in FIG. 1, memory controller 204a, 204b, 304a-304d, 404, 606a, 606b in FIGS. 2A-4 and 6B), an information module (e.g., information module 412 in FIG. 4), an evaluation module (e.g., evaluation module 414 in FIG. 4), or an indicator module (e.g., indicator module 416 in FIG. 4).

The method 700b replaces block 708 of the method 700a with the operations in block 720. Specifically, in response to identifying that the delay for implementing the process for the memory that uses the shared upstream resource does not exceed the delay threshold (i.e., determination block 706=“No”), the memory control device may provide an indication that scheduling of the process for the memory that uses the shared upstream resource should be synchronized. This may enable the memory process that uses the shared upstream resource, such as transaction batching, DRAM memory calibration, or DRAM memory training, to benefit from synchronized implementation between sideband connected memory controllers. In some embodiments, the memory control device providing the indication to the scheduler to synchronize scheduling the process for the memory that uses the shared upstream resource in block 720 may include the processor system, the memory controller, the evaluation module, or the indicator module.

After providing the indication to the scheduler to synchronize scheduling the process for the memory that uses the shared upstream resource in block 720, the memory control device may receive memory control information from the one or more sideband connected memory controllers in block 702 as described.

The methods 700a, 700b may be implemented by a memory control device of a distributed memory control system (e.g., memory control system 200a-200c, 300a-300d, 602b in FIGS. 2A-3D and 6B) for which the memory control device may be configured to provide the indications to the scheduler associated with the memory control device. The methods 700a, 700b may be implemented by a memory control device of a centralized memory control system (e.g., memory control system 200a-200c, 300a-300d, 602b in FIGS. 2A-3D and 6B) for which the memory control device may be configured to provide the indications to the scheduler associated with the memory control device or to the scheduler associated with the one or more sideband connected memory controllers.

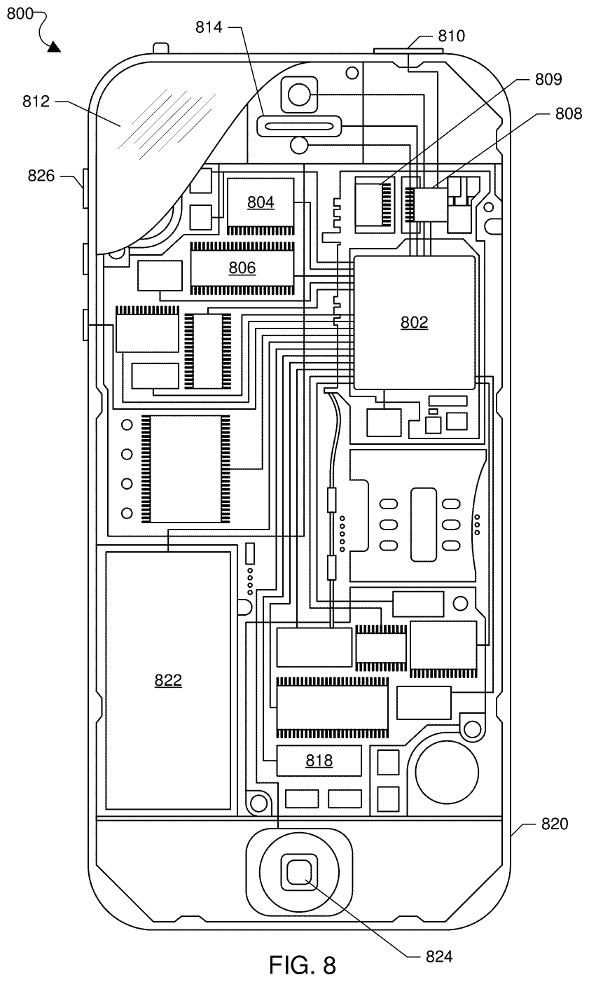

A system in accordance with the various embodiments (including, but not limited to, embodiments described above with reference to FIGS. 1-7B) may be implemented in a wide variety of computing systems, including mobile computing devices, an example of which suitable for use with the various embodiments is illustrated in FIG. 8. The mobile computing device 800 may include a processor 802 coupled to a touchscreen controller 804 and an internal memory 806. The processor 802 may be one or more multicore integrated circuits designated for general or specific processing tasks.

The internal memory 806 may be a volatile or non-volatile memory and may also be secure and/or encrypted memory, unsecured and/or unencrypted memory, or any combination thereof. Examples of memory types that can be leveraged include but are not limited to DDR, Low-Power DDR (LPDDR), Graphics DDR (GDDR), WIDEIO, RAM, Static RAM (SRAM), Dynamic RAM (DRAM), Parameter RAM (P-RAM), Resistive RAM (R-RAM), Magnetoresistive RAM (M-RAM), Spin-Transfer Torque RAM (STT-RAM), and embedded DRAM.

The touchscreen controller 804 and the processor 802 may also be coupled to a touchscreen panel 812, such as a resistive-sensing touchscreen, capacitive-sensing touchscreen, infrared-sensing touchscreen, etc. Additionally, the display of the mobile computing device 800 need not have touchscreen capability.

The mobile computing device 800 may have one or more radio signal transceivers 808 (e.g., Peanut, Bluetooth, ZigBee, Wi-Fi, RF radio) and antennae 810, for sending and receiving communications, coupled to each other and/or to the processor 802. The processor 802 may also be coupled to a cellular network wireless modem 809 that enables communication via a cellular network (e.g., a 5G network) via the antenna 810. The transceivers 808 and antennae 810 may be used with the above-mentioned circuitry to implement the various wireless transmission protocol stacks and interfaces.

The mobile computing device 800 may include a peripheral device connection interface 818 coupled to the processor 802. The peripheral device connection interface 818 may be singularly configured to accept one type of connection or may be configured to accept various types of physical and communication connections, common or proprietary, such as Universal Serial Bus (USB), FireWire, Thunderbolt, or PCIe. The peripheral device connection interface 818 may also be coupled to a similarly configured peripheral device connection port (not shown).

The mobile computing device 800 may also include speakers 814 for providing audio outputs. The mobile computing device 800 may also include a housing 820, constructed of plastic, metal, or a combination of materials, for containing all or some of the components described herein. The mobile computing device 800 may include a power source 822 coupled to the processor 802, such as a disposable or rechargeable battery. The rechargeable battery may also be coupled to the peripheral device connection port to receive a charging current from a source external to the mobile computing device 800. The mobile computing device 800 may also include a physical button 824 for receiving user inputs. The mobile computing device 800 may also include a power button 826 for turning the mobile computing device 800 on and off.

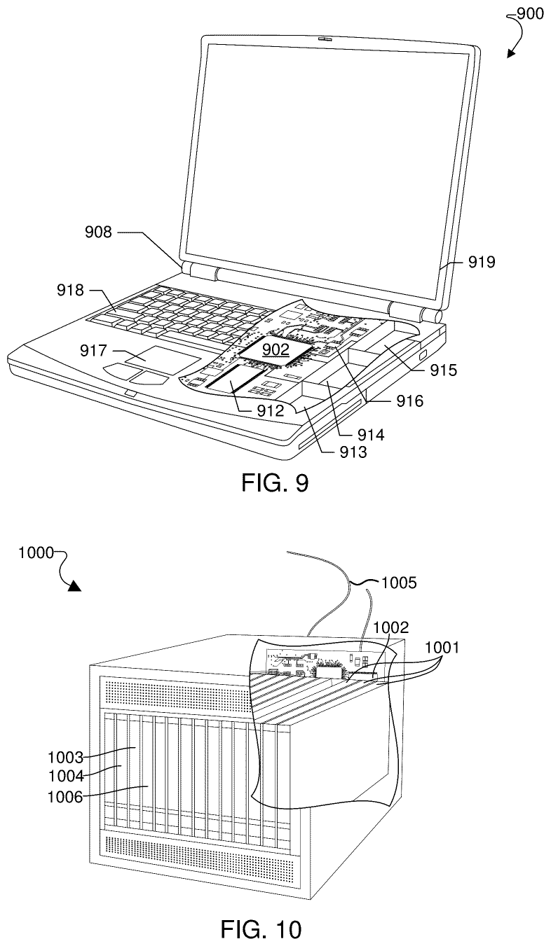

A system in accordance with the various embodiments (including, but not limited to, embodiments described above with reference to FIGS. 1-7B) may be implemented in a wide variety of computing systems, including a laptop computer 900, an example of which is illustrated in FIG. 9. Many laptop computers include a touchpad touch surface 917 that serves as the computer's pointing device and thus may receive drag, scroll, and flick gestures similar to those implemented on computing devices equipped with a touch screen display and described above. A laptop computer 900 will typically include a processor 902 coupled to volatile memory 912 and a large capacity nonvolatile memory, such as a disk drive 913 of Flash memory. Additionally, the computer 900 may have one or more antenna 908 for sending and receiving electromagnetic radiation that may be connected to a wireless data link and/or cellular telephone transceiver 916 coupled to the processor 902. The computer 900 may also include a floppy disc drive 914 and a compact disc (CD) drive 915 coupled to the processor 902. In a notebook configuration, the computer housing includes the touchpad 917, the keyboard 918, and the display 919 all coupled to the processor 902. Other configurations of the computing device may include a computer mouse or trackball coupled to the processor (e.g., via a USB input) as are well known, which may also be used in conjunction with the various embodiments.

A system in accordance with the various embodiments (including, but not limited to, embodiments described above with reference to FIGS. 1-7B) may also be implemented in fixed computing systems, such as any of a variety of commercially available servers. An example server 1000 is illustrated in FIG. 10. Such a server 1000 typically includes one or more multicore processor assemblies 1001 coupled to volatile memory 1002 and a large capacity nonvolatile memory, such as a disk drive 1004. As illustrated in FIG. 10, multicore processor assemblies 1001 may be added to the server 1000 by inserting them into the racks of the assembly. The server 1000 may also include a floppy disc drive, compact disc (CD) or digital versatile disc (DVD) disc drive 1006 coupled to the processor 1001. The server 1000 may also include network access ports 1003 coupled to the multicore processor assemblies 1001 for establishing network interface connections with a network 1005, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

Implementation examples are described in the following paragraphs. While some of the following implementation examples are described in terms of example systems, devices, or methods, further example implementations may include the example systems or devices discussed in the following paragraphs implemented as a non-transitory processor-readable storage medium having stored thereon processor-executable instructions configured to cause a processor of a computing device to perform the operations of the example systems, devices, or methods.

Example 1. A computing system, may include: a first memory controller configured to connect to a shared upstream resource via a first channel and to connect to a first memory via a first memory channel; a second memory controller configured to connect to the shared upstream resource via a second channel and to connect to a second memory via a second memory channel; and a first sideband bus configured to connect the first memory controller with the second memory controller and transmit sideband connected memory controller signals between the first memory controller and the second memory controller.

Example 2. The computing system of example 1, may further include a third memory controller configured to connect to the shared upstream resource via a third channel and to connect to a third memory via a third memory channel, in which the first sideband bus may be further configured to: connect the first memory controller with the third memory controller; connect the second memory controller with the third memory controller; and transmit sideband connected memory controller signals between the first memory controller and the third memory controller and between the second memory controller and the third memory controller.

Example 3. The computing system of example 2, in which: the first channel, the second channel, and the third channel may be subchannels of a fourth channel; and the first memory channel, the second memory channel, and the third memory channel may be memory subchannels of a fourth memory channel.

Example 4. The computing system of example 1, may further include: a third memory controller configured to connect to the shared upstream resource via a third channel and to connect to a third memory via a third memory channel; and a second sideband bus configured to connect the first memory controller and the third memory controller and configured to transmit sideband connected memory controller signals between the first memory controller and the third memory controller.

Example 5. The computing system of example 1, in which: the first channel may be a first subchannel of a third channel and the second channel may be a second subchannel of the third channel; and the first memory channel may be a first memory subchannel of a third memory channel and the second memory channel may be a second memory subchannel of the third memory channel.

Example 6. The computing system of example 1, in which the first channel may be a first subchannel of a third channel and the second channel may be a second subchannel of a fourth channel; and the first memory channel may be a first memory subchannel of a third memory channel and the second memory channel may be a second memory subchannel of a fourth memory channel.

Example 7. The computing system of any of examples 1-6, in which the first sideband bus may be a parallel bus.

Example 8. The computing system of any of examples 1-6, in which the first sideband bus may be a serial bus.

Example 9. The computing system of any of examples 1-8, in which the first memory controller may include a processor system configured to: poll the second memory controller for memory controller information; identify whether the second memory controller is not performing a process for the second memory causing congestion at the shared upstream resource from the memory controller information; and provide a scheduler executed by the processor system with an indication to schedule a process for the first memory that uses the shared upstream resource in response to identifying that the second memory controller is not performing a process for the second memory causing congestion at the shared upstream resource.

Example 10. The computing system of example 9, in which the processor system may be further configured to: identify whether the second memory controller is not scheduled to perform a process for the second memory causing congestion at the shared upstream resource from the memory controller information in response to identifying that the second memory controller is not performing a process for the second memory causing congestion at the shared upstream resource; and provide the scheduler executed by the processor system with the indication to schedule a process for the first memory that uses the shared upstream resource in response to identifying that the second memory controller is not performing a process for the second memory causing congestion at the shared upstream resource and identifying that the second memory controller is not scheduled to perform a process for the second memory causing congestion at the shared upstream resource.

Example 11. The computing system of either of examples 9 or 10, in which in response to identifying that the second memory controller is not performing a process for the second memory causing congestion at the shared upstream resource the processor system may be further configured to: identify whether the second memory controller is scheduled to perform a process for the second memory causing congestion at the shared upstream resource from the memory controller information; identify whether the first memory controller has priority to perform a process for the first memory using the shared upstream resource over the second memory controller; and provide the scheduler executed by the processor system with the indication to schedule a process for the first memory that uses the shared upstream resource in response to identifying that the second memory controller is scheduled to perform a process for the second memory causing congestion at the shared upstream resource, and identifying that the first memory controller has priority to perform a process for the first memory using the shared upstream resource over the second memory controller.

Example 12. The computing system of any of examples 1-11, in which the process for the first memory may be at least one of an all-bank refresh, a per-bank refresh, transaction batching, DRAM memory calibration, or DRAM memory training.

Example 13. The computing system of any of examples 1-12, in which the first memory controller may include a processor system configured to: poll the second memory controller for memory controller information; identify whether the second memory controller is performing a process for the second memory causing congestion at the shared upstream resource from the memory controller information; and provide a scheduler executed by the processor system with an indication to postpone a process for the first memory using the shared upstream resource in response to identifying that the second memory controller is performing a process for the second memory causing congestion at the shared upstream resource.

Example 14. The computing system of any of examples 1-13, in which the first memory controller may include a processor system configured to: poll the second memory controller for memory controller information; identify whether the second memory controller is performing a process for the second memory causing congestion at the shared upstream resource from the memory controller information; identify whether a delay for implementing a process for the first memory using the shared upstream resource exceeds a delay threshold; and provide a scheduler executed by the processor system with an indication to schedule the process for the first memory using the shared upstream resource in response to identifying that the second memory controller is performing a process for the second memory causing congestion at the shared upstream resource and identifying that the delay for implementing the process for the first memory using the shared upstream resource exceeds the delay threshold.

Example 15. The computing system of any of examples 1-12 and 14, in which the first memory controller may include a processor system configured to: poll the second memory controller for memory controller information; identify whether the second memory controller is performing a process for the second memory causing congestion at the shared upstream resource from the memory controller information; and provide a scheduler executed by the processor system with an indication to synchronize a process for the first memory using the shared upstream resource with the process for the second memory causing congestion at the shared upstream resource in response to identifying that the second memory controller is performing a process for the second memory causing congestion at the shared upstream resource.

Computer program code or “program code” for execution on a programmable processor for carrying out operations of the various embodiments may be written in a high-level programming language such as C, C++, C #, Smalltalk, Java, JavaScript, Visual Basic, a Structured Query Language (e.g., Transact-SQL), Perl, or in various other programming languages. References to program code or programs stored on a computer-readable storage medium in this application may include machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, include compact disc (CD), laser disc, optical disc, digital versatile disc (DVD), floppy disc, and Blu-ray disc, where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A computing system, comprising:
a first memory controller configured to connect to a shared upstream resource via a first channel and to connect to a first memory via a first memory channel;
a second memory controller configured to connect to the shared upstream resource via a second channel and to connect to a second memory via a second memory channel; and
a first sideband bus configured to connect the first memory controller with the second memory controller and transmit sideband connected memory controller signals between the first memory controller and the second memory controller.

2. The computing system of claim 1, further comprising a third memory controller configured to connect to the shared upstream resource via a third channel and to connect to a third memory via a third memory channel,
wherein the first sideband bus is further configured to:
connect the first memory controller with the third memory controller;
connect the second memory controller with the third memory controller; and
transmit sideband connected memory controller signals between the first memory controller and the third memory controller and between the second memory controller and the third memory controller.

3. The computing system of claim 2, wherein:
the first channel, the second channel, and the third channel are subchannels of a fourth channel; and
the first memory channel, the second memory channel, and the third memory channel are memory subchannels of a fourth memory channel.

4. The computing system of claim 1, further comprising:
a third memory controller configured to connect to the shared upstream resource via a third channel and to connect to a third memory via a third memory channel; and
a second sideband bus configured to connect the first memory controller and the third memory controller and configured to transmit sideband connected memory controller signals between the first memory controller and the third memory controller.

5. The computing system of claim 1, wherein:
the first channel is a first subchannel of a third channel and the second channel is a second subchannel of the third channel; and
the first memory channel is a first memory subchannel of a third memory channel and the second memory channel is a second memory subchannel of the third memory channel.

6. The computing system of claim 1, wherein
the first channel is a first subchannel of a third channel and the second channel is a second subchannel of a fourth channel; and
the first memory channel is a first memory subchannel of a third memory channel and the second memory channel is a second memory subchannel of a fourth memory channel.

7. The computing system of claim 1, wherein the first sideband bus is a parallel bus.

8. The computing system of claim 1, wherein the first sideband bus is a serial bus.

9. The computing system of claim 1, wherein the first memory controller comprises a processor system configured to:
poll the second memory controller for memory controller information;
identify whether the second memory controller is not performing a process for the second memory causing congestion at the shared upstream resource from the memory controller information; and
provide a scheduler executed by the processor system with an indication to schedule a process for the first memory that uses the shared upstream resource in response to identifying that the second memory controller is not performing a process for the second memory causing congestion at the shared upstream resource.

10. The computing system of claim 9, wherein the processor system is further configured to:
identify whether the second memory controller is not scheduled to perform a process for the second memory causing congestion at the shared upstream resource from the memory controller information in response to identifying that the second memory controller is not performing a process for the second memory causing congestion at the shared upstream resource; and
provide the scheduler executed by the processor system with the indication to schedule a process for the first memory that uses the shared upstream resource in response to identifying that the second memory controller is not performing a process for the second memory causing congestion at the shared upstream resource and identifying that the second memory controller is not scheduled to perform a process for the second memory causing congestion at the shared upstream resource.

11. The computing system of claim 9, wherein in response to identifying that the second memory controller is not performing a process for the second memory causing congestion at the shared upstream resource the processor system is further configured to:
identify whether the second memory controller is scheduled to perform a process for the second memory causing congestion at the shared upstream resource from the memory controller information;
identify whether the first memory controller has priority to perform a process for the first memory using the shared upstream resource over the second memory controller; and
provide the scheduler executed by the processor system with the indication to schedule a process for the first memory that uses the shared upstream resource in response to identifying that the second memory controller is scheduled to perform a process for the second memory causing congestion at the shared upstream resource, and identifying that the first memory controller has priority to perform a process for the first memory using the shared upstream resource over the second memory controller.

12. The computing system of claim 1, wherein the process for the first memory is at least one of an all-bank refresh, a per-bank refresh, transaction batching, DRAM memory calibration, or DRAM memory training.

13. The computing system of claim 1, wherein the first memory controller comprises a processor system configured to:
poll the second memory controller for memory controller information;
identify whether the second memory controller is performing a process for the second memory causing congestion at the shared upstream resource from the memory controller information; and
provide a scheduler executed by the processor system with an indication to postpone a process for the first memory using the shared upstream resource in response to identifying that the second memory controller is performing a process for the second memory causing congestion at the shared upstream resource.

14. The computing system of claim 1, wherein the first memory controller comprises a processor system configured to:
poll the second memory controller for memory controller information;
identify whether the second memory controller is performing a process for the second memory causing congestion at the shared upstream resource from the memory controller information;
identify whether a delay for implementing a process for the first memory using the shared upstream resource exceeds a delay threshold; and
provide a scheduler executed by the processor system with an indication to schedule the process for the first memory using the shared upstream resource in response to identifying that the second memory controller is performing a process for the second memory causing congestion at the shared upstream resource and identifying that the delay for implementing the process for the first memory using the shared upstream resource exceeds the delay threshold.

15. A method of memory controller scheduling implemented by at least one processor system of a first memory controller of a first memory, comprising:
polling a second memory controller for memory controller information via a sideband bus connecting the first memory controller and the second memory controller;
identifying whether the second memory controller is not performing a process for a second memory causing congestion at a shared upstream resource from the memory controller information; and
providing a scheduler executed by the at least one processor system with an indication to schedule a process for the first memory that uses the shared upstream resource in response to identifying that the second memory controller is not performing a process for the second memory causing congestion at the shared upstream resource.

16. The method of claim 15, further comprising, in response to identifying that the second memory controller is not performing a process for the second memory causing congestion at the shared upstream resource:
identifying whether the second memory controller is not scheduled to perform a process for the second memory causing congestion at the shared upstream resource from the memory controller information in response to identifying that the second memory controller is not performing a process for the second memory causing congestion at the shared upstream resource,
wherein providing the scheduler executed by the at least one processor system with the indication to schedule the process for the first memory that uses the shared upstream resource in response to identifying that the second memory controller is not performing a process for the second memory causing congestion at the shared upstream resource comprises providing the scheduler executed by the at least one processor system with the indication to schedule the process for the first memory that uses the shared upstream resource in response to identifying that the second memory controller is not scheduled to perform a process for the second memory causing congestion at the shared upstream resource.

17. The method of claim 15, further comprising, in response to identifying that the second memory controller is not performing a process for the second memory causing congestion at the shared upstream resource:
identifying whether the second memory controller is scheduled to perform a process for the second memory causing congestion at the shared upstream resource from the memory controller information; and
identifying whether the first memory controller has priority to perform a process for the first memory using the shared upstream resource over the second memory controller,
wherein providing the scheduler executed by the at least one processor system with the indication to schedule the process for the first memory that uses the shared upstream resource in response to identifying that the second memory controller is not performing a process for the second memory causing congestion at the shared upstream resource comprises providing the scheduler executed by the at least one processor system with the indication to schedule the process for the first memory that uses the shared upstream resource in response to identifying that the second memory controller is scheduled to perform a process for the second memory causing congestion at the shared upstream resource and identifying that the first memory controller has priority to perform a process for the first memory using the shared upstream resource over the second memory controller.

18. The method of claim 15, wherein the process for the first memory is at least one of an all bank refresh, a per bank refresh, transaction batching, DRAM memory calibration, or DRAM memory training.

19. The method of claim 15, further comprising providing the scheduler executed by the at least one processor system with an indication to postpone the process for the first memory using the shared upstream resource in response to identifying that the second memory controller is performing a process for the second memory causing congestion at the shared upstream resource.

20. The method of claim 15, further comprising:
identifying whether a delay for implementing the process for the first memory using the shared upstream resource exceeds a delay threshold; and
providing a scheduler executed by the at least one processor system with an indication to schedule the process for the first memory using the shared upstream resource in response to identifying that the second memory controller is performing a process for the second memory causing congestion at the shared upstream resource and identifying that the delay for implementing the process for the first memory using the shared upstream resource exceeds the delay threshold.
